(19) United States
(12) Patent Application Publication
(10) Pub. No.: US 2020/0097935 A1
(43) Pub. Date: Mar. 26, 2020

(54) INFORMATION PROCESSING METHOD, INFORMATION PROCESSING DEVICE, AND COMPUTER-READABLE NON-TRANSITORY STORAGE MEDIUM STORING PROGRAM

(71) Applicant: Mercari, Inc., Tokyo (JP)

(72) Inventors: Kazuki Takahashi, Tokyo (JP); David Andreas Mohl, Tokyo (JP)

(21) Appl. No.: 16/578,079

(22) Filed: Sep. 20, 2019

(30) Foreign Application Priority Data
Sep. 21, 2018 (JP) 2018-177112

(51) Int. Cl. G06Q 20/14; G06Q 20/32

(52) U.S. Cl. CPC G06Q 20/14; G06Q 20/3223

(57) ABSTRACT

An information processing method, or the like, which improve user-friendliness in bill splitting processing in settlement service are provided. An information processing method according to the present disclosure causes one or a plurality of processors included in an information processing device to execute processing of transmitting a first information code to a first information processing terminal, processing of specifying account information associated with one or a plurality of other information processing terminals which have scanned the first information code, processing of transmitting the specified account information to the first information processing terminal, processing of transmitting a second information code which is to be utilized for payment, to the first information processing terminal, processing of receiving a request in accordance with scanning of the second information code, and processing of executing bill splitting processing using a split amount of a bill based on the specified account information and a payment amount of the payment after reception of the request.

### CROSS-REFERENCE TO RELATED APPLICATIONS

The present application is based on Japanese Patent Application No. 2018-177112 filed on Sep. 21, 2018, the content of which is incorporated by reference herein.

### BACKGROUND OF THE INVENTION

### Field of the Invention

The present disclosure relates to an information processing method, an information processing device and a computer-readable non-transitory storage medium storing a program.

### Description of the Related Art

In recent years, settlement application for efficiently performing bill splitting processing for collecting cost which is temporarily paid by a user has been developed. For example, Japanese Patent Laid-Open No. 2013-238998 discloses settlement service which is capable of charging other users a split amount of a bill by information associated with the number of persons who are to split a bill and who is charged being input on settlement application.

However, in bill splitting processing in settlement service, there is a problem that procedure of the bill splitting processing is troublesome because it requires a lot of input processing by a user.

It is an object of one aspect of the present disclosure to provide an information processing method, an information processing device, and a computer-readable non-transitory storage medium storing a program, which enable improvement of user-friendliness of bill splitting processing.

### SUMMARY OF THE INVENTION

An information processing method according to an embodiment of the present disclosure to be executed by one or a plurality of processors included in an information processing device, the information processing method including processing of transmitting a first information code to a first information processing terminal, processing of specifying account information associated with one or a plurality of other information processing terminals which have scanned the first information code, processing of transmitting the specified account information to the first information processing terminal, processing of transmitting a second information code which is to be utilized for payment, to the first information processing terminal, processing of receiving a request in accordance with scanning of the second information code, and processing of executing bill splitting processing using a split amount of a bill based on the specified account information and a payment amount of the payment after reception of the request.

### BRIEF DESCRIPTION OF THE DRAWINGS

FIG. 1 illustrates a configuration of a communication system according to one aspect of an embodiment;

FIG. 2 illustrates an example of a hardware configuration of an information processing device according to the present disclosure;

FIG. 3 illustrates an example of a configuration of a server in a first embodiment;

FIG. 4A to 4C illustrate examples of respective management DBs;

FIG. 5 illustrates an example of a configuration of a terminal;

FIG. 6 illustrates an example of an acquiring unit according to the first embodiment;

FIG. 7 illustrates an example of a sequence of processing procedure upon settlement which is performed by a store scanning a code, performed in a communication system according to the first embodiment;

FIG. 8A to 8F illustrate examples of a screen displayed at a terminal 120 according to the first embodiment;

FIG. 9 illustrates an example of a sequence of processing between a server and a terminal according to a first A example;

FIG. 10 illustrates an example of a sequence of processing procedure upon settlement which is performed by a user scanning a code, performed in the communication system according to the first embodiment;

FIG. 11 illustrates an example of a sequence of processing of a communication system according to a first B example;

FIG. 12 illustrates an example of a configuration of a server in a second embodiment;

FIG. 13 illustrates an example of a configuration of a terminal in a second embodiment;

FIG. 14 illustrates an example of a sequence of processing procedure to be performed by a communication system 1 according to the second embodiment;

FIG. 15 illustrates an example of a sequence of processing procedure regarding creation and display of a list of candidates to be performed by each terminal according to the second embodiment;

FIG. 16A to 16E illustrate examples of a screen to be displayed at a terminal 120A according to the second embodiment;

FIG. 17 illustrates an example of a display screen of a list of candidates to be displayed at a terminal 120A according to a first example; and

FIG. 18A and 18B illustrate examples of a display screen for making a completion notification of settlement to be displayed at a terminal 120 according to a second example.

### DETAILED DESCRIPTION OF THE PREFERRED EMBODIMENTS

### <Legal Compliance>

When disclosure of the present specification is implemented, the disclosure is implemented in compliance with laws and regulations of each country in which the present disclosure is to be implemented. Further, the disclosure of the present specification is implemented while all changes, replacements, transformations, modifications, and corrections which are required for complying with laws and regulations of each country and which can be made by a person skilled in the art, are made.

Embodiments for implementing a computer-readable non-transitory storage medium which stores a program, an information processing method, and an information processing device according to the present disclosure will be described with reference to the drawings.

### <System Configuration>

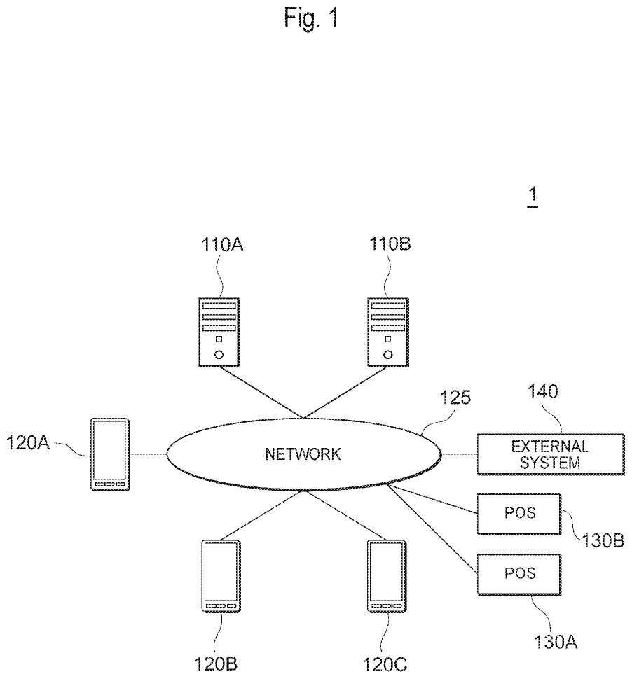

FIG. 1 illustrates a configuration of a communication system 1 according to an embodiment of the present disclosure. As disclosed in FIG. 1, in the communication system 1, a server 110A, a server 110B, a terminal 120A, a terminal 120B, a terminal 120C, a POS (Point of Sales) terminal 130A, a POS terminal 130B, and an external system 140 are connected via a network 125. As a non-limitative example, the external system 140 is constructed with a server, or the like, operated by other business operators (such as a financial institution and a credit company) or other business divisions.

In the present disclosure, in a case where it is not necessary to distinguish between the server 110A and the server 110B, the server 110A and the server 110B may be respectively expressed as servers 110.

In the present disclosure, in a case where it is not necessary to distinguish among the terminal 120A, the terminal 120B and the terminal 120C, the terminal 120A, the terminal 120B and the terminal 120C may be respectively expressed as terminals 120.

In the present disclosure, in a case where it is not necessary to distinguish between the server 110 and the terminal 120, the server 110 and the terminal 120 may be respectively expressed as information processing devices 200. Note that the number of the information processing devices 200 connected to the network 125 is not limited.

The server 110 provides predetermined service to the terminal 120 utilized by a user via the network 125. The predetermined service includes, but not limited to, settlement service, financial service, e-commerce service, SNS (Social Networking Service) typified by an instant messenger, content providing service of music, movie, books, or the like. By the user utilizing the predetermined service via the terminal 120, the server 110 can provide the predetermined service to one or more terminals 120.

In the present disclosure, the settlement service means service which enables one or more users to give or accept money or money equivalent. The settlement service includes, but not limited to, service of performing settlement by utilizing a one-dimensional code (such as a barcode), a two-dimensional code (such as a QR code) and near field communication (such as NFC, BLE, WI-FI and ultrasonic waves). Further, in settlement utilizing an information code such as a one-dimensional code and a two-dimensional code, settlement which is performed by a user who makes settlement scanning the information code will be expressed as “settlement which is performed by a user scanning a code” as necessary, and settlement which is performed by a user who makes settlement displaying an information code and a user (or a store) who charges scanning the information code will be expressed as “settlement which is performed by a store scanning a code” as necessary.

A terminal utilized by a user X will be expressed as a terminal 120X as necessary, and user information in the predetermined service, which is associated with the user X or the terminal 120X will be expressed as user information X as necessary. Note that the user information is information of a user associated with an account utilized by the user in the predetermined service. The user information includes, but not limited to, information associated with the user such as name of the user, an icon image of the user, age of the user, sex of the user, address of the user, preference of the user, and an identifier of the user, balance information of electronic value (electronic money) associated with the user, and credit card information (such as credit card number) associated with the user, which is input by the user or provided by the predetermined service, and may be one of them or combination of them.

The network 125 plays a role of connecting two or more information processing devices 200. The network 125 means a communication network which provides a connection path so that data can be transmitted and received after the terminal 120 is connected to the server 110

One or a plurality of portions among the network 125 may be a wired network or a wireless network. The network 125 can include, but not limited to, an Ad Hoc Network, intranet, extranet, a Virtual Private Network (VPN), a Local Area Network (LAN), a Wireless LAN (WLAN), a Wide Area Network (WAN), a Wireless WAN (WWAN), a Metropolitan Area Network (MAN), part of the Internet, part of a Public Switched Telephone Network (PSTN), a mobile phone network, ISDNs (Integrated Service Digital Networks), wireless LANs, LTE (Long Term Evolution), CDMA (Code Division Multiple Access), Bluetooth (R), satellite communication, or the like, or combination of two or more of these. The network 125 can include one or a plurality of networks.

The information processing devices 200 may be any information processing device if the information processing device can realize processing, functions and/or methods described in the present disclosure.

The information processing devices 200 includes, but not limited to, a smartphone, a mobile phone (future phone), a computer (including, but not limited to, a desktop, a laptop, a tablet, or the like), a server device, a media computer platform (including, but not limited to, a cable, a satellite set top box, a digital video recorder, or the like), a handheld computer device (including, but not limited to, a PDA (Personal Digital Assistant), an e-mail client, or the like), a wearable terminal (including, but not limited to, a spectacle type device, a watch type device, or the like), other kinds of computers, and a communication platform.

The POS terminal 130, which is a terminal utilized by a user (such as a store clerk) who receives payment from a user (customer), includes a two-dimensional code reader and transmits the scanned two-dimensional code to the server 110. The two-dimensional code reader may be a one-dimensional code reader or a three-dimensional code reader. Further, a multidimensional code including a one-dimensional code, a two-dimensional code and a three-dimensional code may be referred to as an information code in the present disclosure.

### <HardWare (HW) Configuration>

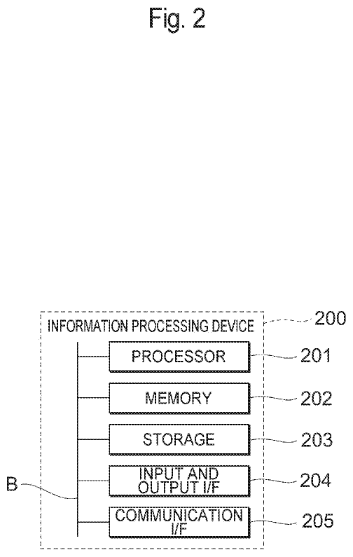

HW configurations of the information processing devices 200 and the POS terminal 130 included in the communication system 1 will be described using FIG. 2.

The information processing devices 200 includes a processor 201, a memory 202, a storage 203, an input/output interface (input/output I/F) 204, and a communication interface (communication I/F) 205. As a non-limitative example, respective components of the HW of the information processing devices 200 are connected to each other via a bus B.

The information processing devices 200 implements processing, functions and/or methods described in the present disclosure in coordination with the processor 201, the memory 202, the storage 203, the input/output I/F 204, and the communication I/F 205.

The processor 201 executes processing, functions and/or methods implemented by codes or commands included in a program stored in the storage 203. The processor 201 includes, but not limited to, one or a plurality of central processing units (CPUs), an MPU (Micro Processing Unit), a GPU (Graphics Processing Unit), a microprocessor, a processor core, a multiprocessor, an ASIC (Application-Specific Integrated Circuit), an FPGA (Field Programmable Gate Array), or the like, and may implement respective kinds of processing disclosed in the respective embodiments by a logical circuit (hardware) or a dedicated circuit which is formed on an integrated circuit (IC) chip, LSI (Large Scale Integration), or the like. Further, these circuits may be implemented with one or a plurality of integrated circuits or a plurality of kinds of processing indicated in the respective embodiments may be implemented with one integrated circuit. Further, there is also a case where the LSI is referred as a VLSI, a super LSI, an ultra LSI, or the like, depending on a difference in an integration degree.

The memory 202 temporarily stores a program loaded from the storage 203 and provides a work area for the processor 201. Various kinds of data generated while the processor 201 executes the program are also temporarily stored in the memory 202. The memory 202 includes, but not limited to, a RAM (Random Access Memory), a ROM (Read Only Memory), or the like.

The storage 203 stores a program for executing processing, functions and/or methods disclosed below. The storage 203 includes, but not limited to, an HDD (Hard Disk Drive), an SSD (Solid State Drive), a flash memory, or the like.

The communication I/F 205 performs transmission and reception of various kinds of data via the network 125. The communication may be executed either in a wired manner or in a wireless manner, and any communication protocol may be used if it is possible to perform communication with each other. The communication I/F 205 executes communication with other information processing devices via the network 125. The communication I/F 205 transmits various kinds of data to other information processing devices in accordance with an instruction from the processor 201. Further, the communication I/F 205 receives various kinds of data transmitted from other information processing devices and transfer the data to the processor 201.

The input/output I/F 204 includes an input device which inputs various kinds of operation to the information processing devices 200 and an output device which outputs a processing result processed at the information processing devices 200. The input/output I/F 204 may be a device in which an input device and an output device are integrated, or may be an input device and an output device which are separated.

The input device is implemented by one or combination of all types of devices which can accept input from the user and transfer information relating to the input to the processor 201. The input device includes, but not limited to, a hardware key such as a touch panel, a touch display and a keyboard, a pointing device such as a mouse, a camera (operation input via an image), and a microphone (operation input using speech).

The output device is implemented by one or combination of all types of devices which can output a processing result processed at the processor 201. In a case where the processing result is output as an image and/or a moving image, the output device is implemented by one or combination of all types of devices which can display display data in accordance with the display data written in a frame buffer. The output device includes, but not limited to, a touch panel, a touch display, a monitor (including, but not limited to, a liquid crystal display, an GELD (Organic Electroluminescence Display), or the like), a head mounted display (HMD), projection mapping, a hologram, a device which can display an image, text information, or the like, in the air, or the like, (also in vacuum), a speaker (speech output), a printer, or the like. Note that these output devices may be able to display display data in three dimensions.

A program in the respective embodiments of the present disclosure may be provided in a state where the program is stored in a computer-readable storage medium. The storage medium can store a program in a “non-transitory tangible medium”. The program includes, but not limited to, a software program and a computer program.

The storage medium can include, if appropriate, one or a plurality of semiconductor-based integrated circuits or other integrated circuits (ICs) (including, but not limited to, a field programmable gate array (FPGA), an application specific IC (ASIC), or the like), a hard disk drive (HDD), a hybrid hard drive (HHD), an optical disk, an optical disk drive (ODD), a magneto-optical disk, a magneto-optical disk drive, a floppy diskette, a floppy disk drive (FDD), a magnetic tape, a solid drive (SSD), a RAM drive, a secure digital card or drive, arbitrary other appropriate storage media, or appropriate combination of two or more of these. The storage medium may be, if appropriate, volatile, non-volatile or combination of volatile and non-volatile.

Further, the program of the present disclosure may be provided to the information processing devices 200 via an arbitrary transmission medium (such as a communication network and a broadcast wave) which can transmit the program.

Further, the respective embodiments of the present disclosure can be implemented in a form of a data signal embedded in a carrier wave which is embodied by the program being electronically transmitted.

Note that the program of the present disclosure is implemented using methods including, but not limited to, script language such as JavaScript (R) and Python, C language, Go language, Swift, Kotlin, Java (R), or the like.

At least part of processing at the information processing devices 200 may be implemented by cloud computing which is configured by one or more computers.

It is also possible to employ a configuration where at least part of processing at the information processing devices 200 is performed by other information processing devices. In this case, it is also possible to employ a configuration where at least part of processing among processing of respective parts to be implemented by the processor 201 is performed by other information processing devices.

### <Other>

Unless explicitly mentioned, a configuration of determination in embodiments of the present disclosure is not essential, and predetermined processing may be performed in a case where determination conditions are satisfied, or predetermined processing may be performed in a case where determination conditions are not satisfied.

In the present disclosure, unless explicitly mentioned, or unless indicated by the context, “or” does not have exclusive meaning but has inclusive meaning. Therefore, in the present disclosure, unless explicitly mentioned, or unless indicated by the context, “A or B” means “A, B or both of them”. Further, “at least one of A and B” means “A, B or both of them”. Still further, unless explicitly mentioned, or indicated by the context, “a”, “an” or “the” means “one or a plurality of”. Therefore, in the present specification, unless otherwise explicitly mentioned, or indicated by the context, “an A” or “the A” means “one or a plurality of A”.

The present disclosure incorporates all changes, replacements, transformations, modifications and corrections which can be performed by a person skilled in the art for embodiments and/or examples of the present disclosure. In a similar manner, if appropriate, the appended claims incorporate all changes, replacements, transformations, modifications and corrections which can be performed by a person skilled in the art for embodiments and/or examples of the present disclosure. Further, the present disclosure also incorporates arbitrary combination of one or a plurality of features of embodiments and/or examples in the present disclosure which can be performed by a person skilled in the art, and one or a plurality of features of other embodiments and/or examples in the present disclosure.

In addition, reference in the appended claims for a device or a system or components of a device or a system which is adapted, is disposed, has ability, is configured, can be used, or can operate to implement specific functions incorporates the device, the system and the components regardless of whether or not the device, the system, the components or the specific functions is activated, turned on or unlocked, as long as the device, the system or the components is adapted, is disposed, has ability, is configured, can be used, or can operate.

Unless explicitly mentioned, in the present disclosure, to implement one of the embodiments or the examples, agreement from the user may be acquired in advance or immediately before implementation. Further, the agreement may be comprehensively acquired or may be acquired each time.

### First Embodiment

A first embodiment is an embodiment which enables bill splitting processing when the user receives settlement service using an information code through on-line processing by way of the network 125 using the terminal 120.

The information code is a code including a multidimensional code such as a one-dimensional code, a two-dimensional code and a three-dimensional code. Note that the one-dimensional code may include, but not limited to, a barcode. Further, the two-dimensional code may include, but not limited to, a QR code (R), AztecCode, PDF417, or the like. The three-dimensional code may include, but not limited to, a PM code (R), or the like, which is combination of color and the QR code (R). While, in the following description, for convenience of explanation, description will be provided assuming that settlement is made using a two-dimensional code, the first embodiment and a second embodiment can be applied to settlement using a multidimensional code including a one-dimensional code or a three-dimensional code.

In one aspect of settlement which is performed by a store scanning a code in the first embodiment, the terminal 120 of a user who is to split a bill scans a two-dimensional code displayed at the terminal 120 who is to make payment and transmits the two-dimensional code to the server 110. The terminal 120 of the user who is to make payment acquires the total number of users who are to split a bill on the basis of account information of users who are to split the bill transmitted from the server 110. The terminal 120 of the user who is to make payment acquires a split amount of the bill using the acquired total number and transmits a settlement request including the split amount of the bill to the server 110. By this means, it is possible to easily execute bill splitting processing without the user performing troublesome procedure.

Further, in one aspect of settlement which is performed by a store scanning a code in the first embodiment, in a case where the user who is to split a bill has predetermined relationship with the user who is to make payment, bill splitting processing is executed. Further, in the present aspect, it is also possible to have a full amount of a payment amount paid by another user who has predetermined relationship with the user who is to make payment on behalf of the user. By this means, it is possible to prevent part or full amount of a payment amount from being paid by others with no relationship without permission, so that it is possible to improve security.

Further, in one aspect of settlement which is performed by a user scanning a code in the first embodiment, the terminal 120 of the user who is to make payment scans a two-dimensional code posted at a store, or the like, or a two-dimensional code displayed at the POS terminal 130, or the like, generates a two-dimensional code for bill splitting on the basis of the scanned two-dimensional code and displays the generated two-dimensional code on a screen. The subsequent processing is similar to processing upon settlement which is performed by a store scanning a code, and bill splitting processing or settlement processing is performed by the terminal 120 of the user who is to split a bill scanning the two-dimensional code displayed at the terminal 120 of the user who is to make payment. By this means, it is possible to easily perform bill splitting processing without the user performing troublesome procedure.

Further, in one aspect of settlement which is performed by a user scanning a code in the first embodiment, the terminal 120 of each user who is to split a bill scans a two-dimensional code posted at a store, or the like, or a two-dimensional code displayed at the POS terminal 130, or the like, and transmits information included in the scanned two-dimensional code, account information of each user, or the like, to the server 110. The server 110 calculates the total number of users who are to split the bill and a split amount of the bill on the basis of the received information and transmits the calculated information to each terminal 120. By this means, even in a case where settlement is performed by a user scanning a code, it is possible to easily execute bill splitting processing without the user performing troublesome procedure. Further, because the terminal 120 side is only required to scan the two-dimensional code, display the split amount of the bill, and transmit a request for settlement processing, which does not require substantial calculation processing, it is possible to improve processing speed of the terminal 120.

Further, because the technology disclosed in the first embodiment can be introduced without a change being made in an existing system on the store side or a two-dimensional code which has already being posted, it is possible to easily apply the technology of the present disclosure also on the store side.

### <Configuration of First Embodiment>

### (1) Configuration of Server

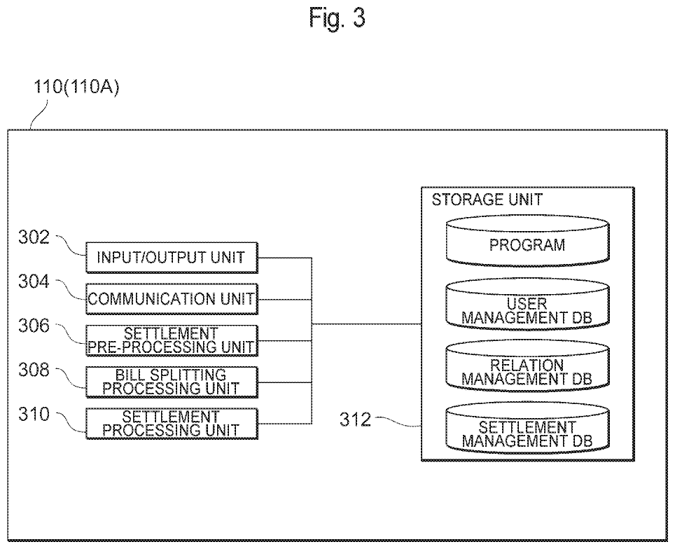

FIG. 3 illustrates an example of a configuration of the server 110 in the first embodiment. The respective units disclosed in FIG. 3 are implemented in coordination with the processor 201, the memory 202, the storage 203, the input/output I/F 204, and the communication I/F 205 provided at the information processing devices 200.

The server 110 includes, for example, an input/output unit 302, a communication unit 304, a settlement pre-processing unit 306, a bill splitting processing unit 308, a settlement processing unit 310 and a storage unit 312. The input/output unit 302 can be implemented using, for example, the input/output I/F 204. Further, the communication unit 304 can be implemented using, for example, the communication I/F 205. The settlement pre-processing unit 306, the bill splitting processing unit 308 and the settlement processing unit 310 can be implemented by the processor 201 reading out and executing the program stored in the storage unit 312. The storage unit 312 can be implemented using the memory 202 and/or the storage 203.

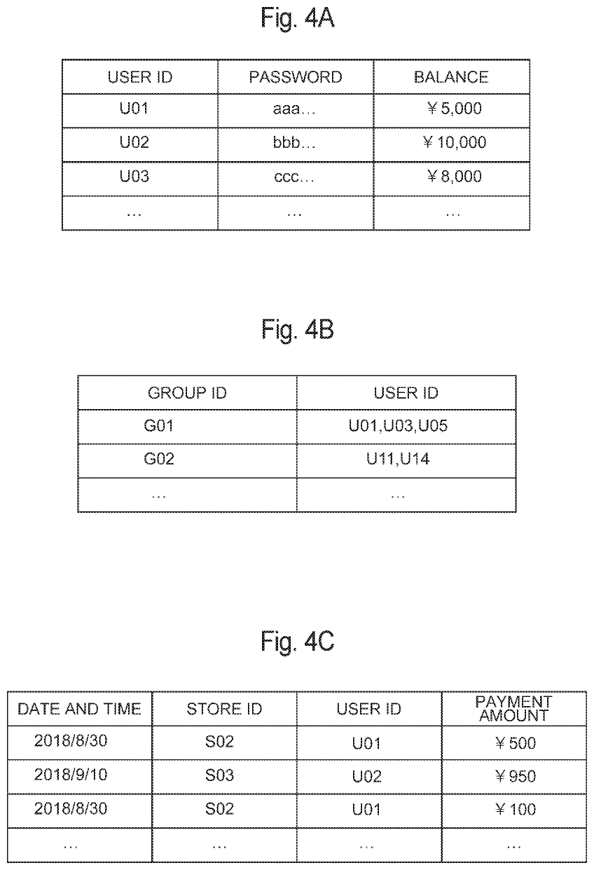

The storage unit 312 stores a program to be executed by the server 110 according to the first embodiment, a user management DB (DataBase) which manages account information of the user who utilizes settlement using a two-dimensional code, a relation management DB which manages predetermined relationship between users, and a settlement management DB which manages history of settlement processing performed by the user. FIG. 4 illustrates examples of respective management DBs.

FIG. 4A illustrates an example of the user management DB. In the user management DB, information regarding an account of each user created by a settlement service provider is managed. In a “user ID”, user identification information (ID: Identifier) to be used by the server 110 to uniquely identify the user is stored. In a “password”, a password for performing user authentication is stored. In “balance”, balance of money possessed by the user is stored. Note that, while not illustrated in FIG. 4A, the user management DB may temporarily store information of a two-dimensional code issued by the terminal 120 of the user. The information of the two-dimensional code may include, but not limited to, code identification information for identifying the two-dimensional code, expiration date of the two-dimensional code, or the like. Part or all of the information managed in the user management DB will be also referred to as account information.

FIG. 4B illustrates an example of the relation management DB. In a “group ID”, identification information for identifying predetermined relationship of the user is stored. In a “user ID”, user identification information of a user who has predetermined relationship is stored.

The predetermined relationship means that the server 110 stores predetermined relationship between two or more users. The predetermined relationship may include, but not limited to, relationship in which relationship building is approved by each other, relationship in which at least one requests for relationship building, relationship built on the basis of user information, relationship built on the basis of user behavior, and a state where relationship is built by predetermined conditions being satisfied. Note that the relationship built on the basis of user information may include relationship which is associated between users having one or more pieces of the same or similar user information, and the relationship built on the basis of user behavior may include relationship which is associated between users having one or more pieces of the same or similar user behavior.

Further, the user who has predetermined relationship with the user may include, but not limited to, all the users who have predetermined relationship with the user, a predetermined number of users determined in advance, or users whose intimacy is equal to or higher than a predetermined degree.

Here, the intimacy may be a degree determined so that the intimacy becomes higher in descending order of an amount of transmission and reception of messages transmitted and received with the user during a predetermined period (which may be a period fixed in advance such as one month or two months or which may be a period from when the predetermined relationship is built until now). Further, the intimacy may be a degree determined so that the intimacy becomes higher in descending order of the number of times of transaction (including buying and selling of products, transmission and reception, and exchange of money of assets, or the like), within a predetermined period.

Further, the intimacy may be a degree determined so that the intimacy becomes higher as a length of a period from when the predetermined relationship is built until now is longer. The length of the period from when the predetermined relationship is built until now may be an absolute value or may be a relative value among one or more users having the predetermined relationship with the user.

Further, the intimacy may be a degree determined so that the intimacy becomes higher as a length of a period of time during which other users are located within a predetermined range from a location of the user is longer, for a plurality of other users having the predetermined relationship with the user. Further, the intimacy may be a degree determined so that the intimacy becomes higher as relationship (for example, estimated as family relationship, or the like), estimated on the basis of a period from when the predetermined relationship is built until now and location information of the respective users is higher, for a plurality of users having the predetermined relationship with the user.

Further, the intimacy may be a degree determined so that the intimacy becomes higher as the number of users common with the user (the number of common friends) is larger, for a plurality of other users having the predetermined relationship with the user.

Further, the intimacy may be a degree determined so that the intimacy becomes higher as the number of users having the predetermined relationship with the user himself/herself is larger, among users who build the predetermined relationship with a user with whom the user communicates.

Further, the intimacy may be a degree determined so that the intimacy becomes higher as a degree of similarity is higher between attribute of the user himself/herself and attribute of each of a plurality of users having the predetermined relationship with the user. The attribute of the user may include, but not limited to, interest.

As a non-limitative example, a group ID of “G01” illustrated in FIG. 4B indicates a family, and users indicated with user IDs of “U01”, “U03” and “U05” indicate family members of one family. A new group and users may be registered in the relation management DB by an administrator who administrates this database.

FIG. 4C illustrates an example of the settlement management DB. In “date and time”, date and time at which settlement using the two-dimensional code has been completed is stored. In a “store ID”, store information (also referred to as a store ID) of a store at which settlement using a two-dimensional code has been performed is stored. Note that the store ID may be an ID of the POS terminal 130 in a case where there are a plurality of POS terminals 130 at the store. In a “payment amount”, a payment amount when settlement using the two-dimensional code has been performed is stored. Further, the settlement management DB may manage a settlement ID in a case where there is a settlement ID, or the like, which is information for identifying settlement. By this means, it is possible to easily search for settlement information.

The input/output unit 302 performs processing of accepting input of various kinds of data via the input/output I/F 204 and processing of outputting various kinds of data via the input/output I/F 204.

The communication unit 304 performs processing of receiving various kinds of data from the terminal 120 and the POS terminal 130 via the communication I/F 205 and processing of transmitting various kinds of data to the terminal 120 and the POS terminal 130 using the communication I/F 205.

The settlement pre-processing unit 306 performs pre-processing for making settlement on the basis of the account information transmitted from the terminal 120 of each user. The settlement pre-processing is processing for acquiring a split amount of a bill, and includes various kinds of processing. For example, the settlement pre-processing unit 306 transmits account information of the user to a predetermined terminal 120 in response to a transmission request of account information from the terminal 120. Further, the settlement pre-processing unit 306 may obtain a total number of users who are to split a bill or may obtain a split amount of a bill by dividing a payment amount by the total number of users on the basis of the transmitted account information of each user.

The bill splitting processing unit 308 performs processing of subtracting (withdrawing) a split amount of a bill from balance of a user for whom payment is temporarily paid and adding (paying) the amount to balance of a user who has made payment. Further, the bill splitting processing unit 308 may perform processing of withdrawing and paying a split amount of a bill after or before settlement processing which will be described later.

The settlement processing unit 310 performs various kinds of processing for executing settlement using a two-dimensional code. Specifically, the settlement processing unit 310 performs settlement processing on the basis of information included in a settlement request. The settlement processing includes processing of subtracting a payment amount from balance of a user who is to make payment and paying the payment amount to an account of a store specified from the settlement request, or the like. Here, the account of the store includes an account possessed by the store. Paying (depositing)/withdrawing of the payment amount to/from the account of the store includes adding/subtracting of the payment amount to/from balance of the account of the store.

Subsequently, specific configurations of the communication unit 304, the settlement pre-processing unit 306, the bill splitting processing unit 308 and the settlement processing unit 310 will be described separately in a case of settlement which is performed by a store scanning a code and in a case of settlement which is performed by a user scanning a code in settlement using a two-dimensional code.

(A) Configuration of Server in Settlement which is Performed by Store Scanning Code

The communication unit 304 may be configured as a receiving unit (first A receiving unit) which receives account information of a user who is to split a bill, a user ID of a user who is to make payment, or the like, from each terminal 120 which has scanned a two-dimensional code displayed at the terminal 120 of the user who is to make payment (for example, a user A). The two-dimensional code includes, for example, the user A who is to make payment and who generates this two-dimensional code, and/or a payment amount. The account information includes, but not limited to, a user ID and a password of a user who is to split a bill (for example, a user B and a user C) who utilizes the terminal 120 which has scanned the two-dimensional code. Further, the communication unit 304 may be configured as a transmitting unit (first A transmitting unit) which transmits the received account information of the user who is to split a bill, a result of settlement pre-processing based on the user ID of the user who is to make payment, or the like, to the terminal 120 of the user who is to make payment.

Further, the communication unit 304 may be configured as a receiving unit (second A receiving unit) which receives a request for account authentication and balance confirmation of each user who is to split a bill from the terminal 120 of the user who is to make payment. The request for account authentication and balance confirmation includes, for example, account information of the user who is to split a bill and a split amount of a bill. Further, the communication unit 304 may be configured as a transmitting unit (second A transmitting unit) which transmits a result of account authentication and balance confirmation of each user who is to split a bill to the terminal 120 of the user who is to make payment. The result of account authentication and balance confirmation includes, for example, success or failure of account authentication based on the user ID and the password of the user who is to split a bill, and a result as to whether or not balance associated with an account of the user who is to split a bill is equal to or greater than a split amount of a bill.

Further, the communication unit 304 may be configured as a receiving unit (third A receiving unit) which receives a settlement request for paying a payment amount to a store side from the POS terminal 130 which has scanned the two-dimensional code displayed at the terminal 120 of the user who is to make payment. The settlement request includes, for example, a store ID associated with the POS terminal 130 which has scanned the two-dimensional code, a payment amount, a user ID of the user who is to make payment, or the like. Further, the communication unit 304 may be configured as a transmitting unit (third A transmitting unit) which transmits a completion notification of settlement to the POS terminal 130 and/or the terminal 120 of the user who is to make payment.

The settlement pre-processing unit 306 performs pre-processing for making settlement on the basis of the account information of the user who is to split a bill, the user ID of the user who is to make payment, or the like, received by the first A receiving unit. The settlement pre-processing unit 306, for example, specifies the user who is to make payment from the user ID of the user who is to make payment. The settlement pre-processing unit 306 then gives an instruction to transmit the account information of the user who is to split a bill to the terminal 120 of the user who is to make payment via the first A transmitting unit. Further, in a case where the settlement pre-processing unit 306 can acquire the payment amount, the settlement pre-processing unit 306 may calculate a split amount of a bill in accordance with the total number of pieces of account information received within a predetermined period, and transmit the split amount of the bill to the terminal 120 of the user who is to make payment. In this case, the split amount of the bill may be calculated when a request for calculating the split amount of the bill is received from the terminal 120 of the user who is to make payment. By this means, an appropriate split amount of a bill is calculated after the number of persons who are to split the bill is determined.

Further, the settlement pre-processing unit 306 performs account authentication processing and balance confirmation processing in response to a request for account authentication and balance confirmation of the user who is to split the bill received by the second A receiving unit. The settlement pre-processing unit 306 makes an inquiry to the user management DB on the basis of the account information received by the second A receiving unit and determines whether or not the user who is to split a bill is successfully authenticated as the account authentication processing. Further, the settlement pre-processing unit 306 makes an inquiry to the user management DB on the basis of the split amount of the bill received by the second A receiving unit and determines whether or not balance of the user who is to split the bill is equal to or greater than the split amount of the bill as the balance confirmation processing. Further, the settlement pre-processing unit 306 gives an instruction to transmit a result of the account authentication and a result of the balance confirmation to the terminal 120 of the user who is to make payment via the second A transmitting unit.

The bill splitting processing unit 308 performs bill splitting processing of specifying accounts of respective users who are to split a bill other than the user who is to make payment in response to the settlement request received by the third A receiving unit, subtracting the split amount of the bill from balance of the respective users associated with the specified accounts and adding the amount to balance of the user who is to make payment. Further, the bill splitting processing unit 308 transmits a completion notification of the bill splitting processing to the terminal 120 of the user who is to make payment via the third A transmitting unit.

The settlement processing unit 310 performs settlement processing of paying a payment amount which is subtracted from the balance of the user who is to make payment, to an account of the store associated with the store ID in response to the settlement request received by the third A receiving unit. The settlement processing is performed using the external system 140. Further, the settlement processing unit 310 transmits the completion notification of the settlement processing to the POS terminal 130 which has scanned the two-dimensional code and/or the terminal 120 of the user who is to make payment via the third A transmitting unit. Note that, as described above, while the order of the bill splitting processing and the settlement processing does not matter, and either the bill splitting processing or the settlement processing may be performed first, in the present disclosure, an example will be described where the bill splitting processing is performed first to prevent the user who is to make payment from failing to collect the split amount of the bill.

Further, the settlement pre-processing unit 306 may determine whether or not to execute the bill splitting processing in accordance with predetermined relationship between the user of the terminal 120 which has displayed the two-dimensional code and the user of the terminal 120 which has scanned this two-dimensional code. In this case, the settlement pre-processing unit 306 makes an inquiry to the relation management DB as to whether or not there is predetermined relationship between the user ID of the user who is to make payment received by the first A receiving unit and the user ID included in the account information. The settlement pre-processing unit 306 acquires a result of the inquiry and transmits a determination result indicating the predetermined relationship between the users to the terminal 120 of the user who is to make payment via the first A transmitting unit. For example, in a case where there is predetermined relationship (such as, for example, family and friends at the university) between the user who is to make payment and the user who is to split a bill, it is possible to execute the bill splitting processing. By this means, it is possible to prevent bill splitting processing with a user who does not have the predetermined relationship, so that it is possible to improve security.

Further, the technology of the present disclosure can be applied also to processing in which, in place of the user of the terminal 120 which has displayed the two-dimensional code, the user of the terminal 120 which has scanned this two-dimensional code pays a full amount, as well as the bill splitting processing. For example, in a case where a user B who is a parent of a user A performs settlement for the user A who is a child, a two-dimensional code including representative information indicating that payment is not split but is made on behalf of the user A is displayed at the terminal 120A of the user A. At this time, the terminal 120B of the user B scans the two-dimensional code, and the representative information and the user ID of the user A included in the two-dimensional code, and account information of the user B added on the terminal 120B side are transmitted to the server 110. The settlement pre-processing unit 306 determines the predetermined relationship between the users on the basis of the user ID of the user A, and a user ID of the user B included in the account information of the user B. The settlement pre-processing unit 306 allows representative payment in a case where there is the predetermined relationship between the users. By this means, it is possible to prevent representative payment by a user who does not have the predetermined relationship, so that it is possible to improve security.

(B) Configuration of Server in Settlement which is Performed by User Scanning Code

The communication unit 304 may be configured as a receiving unit (first B receiving unit) which receives from each terminal 120 which has scanned the two-dimensional code (for example, the two-dimensional code posted at a predetermined position of a store or displayed at the POS terminal 130) associated with the store, settlement information included in this two-dimensional code, the account information of the user of the terminal 120 which has scanned the two-dimensional code, or the like. The settlement information includes, for example, a payment amount, or the like. Further, the communication unit 304 may be configured as a transmitting unit (first B transmitting unit) which transmits a result of settlement pre-processing based on the received each piece of account information to each terminal 120 which has transmitted the settlement information. The result of the settlement pre-processing may include, for example, a split amount of a bill obtained by dividing the payment amount by the total number of users associated with the received respective pieces of account information. Further, the communication unit 304 may be configured as a receiving unit (second B receiving unit) which receives a settlement request from each terminal 120. Further, the communication unit 304 may be configured as a transmitting unit (second B transmitting unit) which transmits a completion notification of bill splitting processing and/or settlement processing processed in response to the settlement request to the POS terminal 130 which has displayed the two-dimensional code and/or each terminal 120 which has scanned the two-dimensional code.

Note that, in settlement which is performed by a user scanning a code, the terminal 120 of the user who is to make payment may scan the two-dimensional code displayed at the POS terminal 130, and this terminal 120 may generate a two-dimensional code for bill splitting processing and cause each terminal 120 of the user who is to split the bill to scan the generated two-dimensional code. In this case, while a configuration on the server 110 side thereafter is similar to a configuration in a case of settlement which is performed by a store scanning a code, the settlement request may be transmitted from the terminal 120 of the user who is to make payment. Therefore, in the following description, description will be provided using an example where each terminal 120 of the user who is to split a bill scans the two-dimensional code displayed at the POS terminal 130, or the like.

The settlement pre-processing unit 306 obtains the total number of users (users who are to split a bill) associated with the respective pieces of account information received by the first B receiving unit and calculates the split amount of the bill using at least part of this total number and a payment amount as settlement pre-processing. For example, the settlement pre-processing unit 306 transmits a result of settlement pre-processing including the split amount of the bill calculated by dividing the payment amount by the total number to the terminal 120 of each user via the first B transmitting unit. By this means, because the split amount of the bill is calculated on the server side, it is possible to reduce processing load on the terminal 120 side.

Further, the settlement pre-processing unit 306 may transmit the total number of users who are to split a bill to the terminal 120 of each user via the first B transmitting unit as settlement pre-processing. In this case, because the split amount of the bill is calculated on the terminal 120 side, each terminal 120 does not have to transmit the payment amount to the server 110 side.

The bill splitting processing unit 308 subtracts and withdraws the split amount of the bill calculated by the settlement pre-processing unit 306 from balance of each user who is to split the bill who utilizes each terminal 120 which has transmitted the settlement request in response to the settlement request received by the second B receiving unit.

The settlement processing unit 310 performs settlement processing of paying each split amount of the bill subtracted by the bill splitting processing unit 308 to an account of a store associated with a store ID included in the settlement request. Further, the settlement processing unit 310 transmits a completion notification of settlement processing to the POS terminal 130 which has displayed the two-dimensional code and/or each terminal 120 which has scanned the two-dimensional code via the second B transmitting unit.

Note that, in a case of settlement which is performed by a user scanning a code, the bill splitting processing unit 308 and the settlement processing unit 310 may coordinate with each other in processing from the above-described withdrawing of the split amount of the bill to depositing of the amount to the account of the store. Further, in a case where the split amount of the bill is calculated on the terminal 120 side, the settlement request transmitted from the terminal 120 may include the split amount of the bill. In this case, the bill splitting processing unit 308 may subtract and withdraw the split amount of the bill included in the settlement request received by the second receiving unit from balance of each user who is to split the bill.

Other possible examples in settlement which is performed by a user scanning a code can include pre-check-in. For example, at each table of a restaurant, a two-dimensional code which is converted identification information (hereinafter, also referred to as a payee ID) for identifying this table or the restaurant is posted or displayed on a screen of the terminal 120 provided at the table. Each user who is seated at the table scans the two-dimensional code using the own terminal 120 to perform check-in processing. In the check-in processing, each terminal 120 transmits the scanned payee ID and account information of the user to the server 110.

Then, on the store side, after order at this table is all completed, check-out processing is performed in response to an instruction from the user. In the check-out processing, for example, if the user gives an instruction to complete the order on the terminal 120 provided at the table, a payee ID and a payment amount are transmitted to the server 110 from this terminal 120. If the settlement pre-processing unit 306 of the server 110 acquires the payment amount, the settlement pre-processing unit 306 calculates the split amount of the bill using at least part of the number of users who has checked in (users who are to split the bill) and the payment amount. The subsequent processing is similar to the above-described processing of the settlement which is performed by a user scanning a code. By this means, the user can finish payment quickly without standing in checkout line for payment.

### (2) Configuration of Terminal

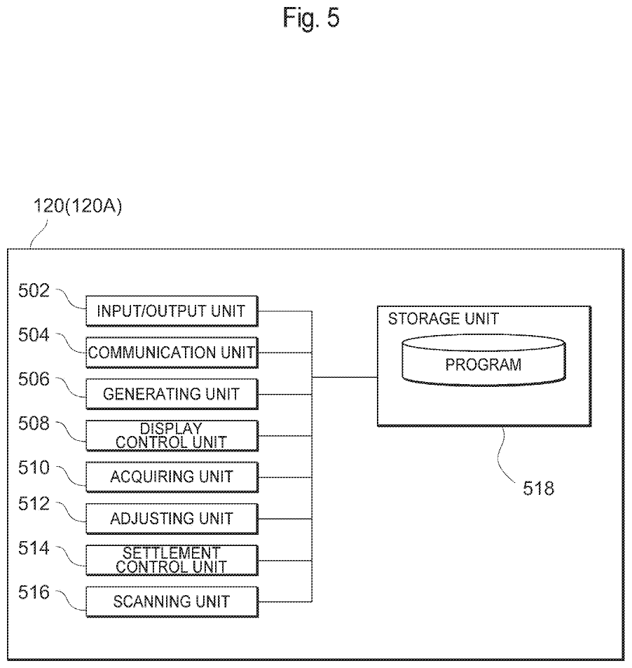

A configuration of the terminal 120 will be described using FIG. 5. The respective parts disclosed in FIG. 5 are implemented in coordination with the processor 201, the memory 202, the storage 203, the input/output I/F 204 and the communication I/F 205 provided at the information processing devices 200.

The terminal 120 includes an input/output unit 502, a communication unit 504, a generating unit 506, a display control unit 508, an acquiring unit 510, an adjusting unit 512, a settlement control unit 514, a scanning unit 516 and a storage unit 518. The input/output unit 502, the communication unit 504, the generating unit 506, the display control unit 508, the acquiring unit 510, the adjusting unit 512, the settlement control unit 514 and the scanning unit 516 are implemented by the processor 201 reading out and executing a program stored in the storage unit 518. The storage unit 518 is implemented using the memory 202 and/or the storage 203. As described above, because settlement using a two-dimensional code includes settlement which is performed by a store scanning a code and settlement which is performed by a user scanning a code, first, a configuration of the terminal 120 in settlement which is performed by a store scanning a code will be described, and then, a configuration of the terminal 120 in settlement which is performed by a user scanning a code will be described.

(A) Configuration of Terminal in Settlement which is Performed by Store Scanning Code

The input/output unit 502 performs processing of accepting input of various kinds of data via the input/output I/F 204 and processing of outputting various kinds of data via the input/output I/F 204.

The communication unit 504 performs processing of receiving various kinds of data from the server 110 via the communication I/F 205 and processing of transmitting various kinds of data to the server 110 using the communication I/F 205. The communication unit 504 may be configured as a receiving unit (fourth A receiving unit) which receives respective pieces of account information of the users who are to split a bill on the basis of settlement pre-processing processed by the server 110 which has received the account information of the users who are to split the bill, a user ID of the user who is to make payment, or the like. The account information includes, but not limited to, user IDs and passwords of the users who are to split the bill who utilize the terminals 120 which have scanned the two-dimensional code.

Further, the communication unit 504 may be configured as a transmitting unit (fourth A transmitting unit) which transmits a request for account authentication and balance confirmation of the respective users who are to split the bill to the server 110. The request for account authentication and balance confirmation includes, for example, account information of the users who are to split the bill and the split amount of the bill. Further, the communication unit 504 may be configured as a receiving unit (fifth A receiving unit) which receives results of account authentication and balance confirmation of the respective users who are to split the bill from the server 110. The result of account authentication and balance confirmation includes, for example, success or failure of account authentication based on the user IDs and the passwords of the users who are to split the bill and results as to whether or not balance associated with the accounts of the users who are to split the bill is equal to or greater than the split amount of the bill.

Further, the communication unit 504 may be configured as a transmitting unit (fifth A transmitting unit) which transmits a settlement request for paying a payment amount to a store side, to the POS terminal 130 which has scanned the two-dimensional code displayed at the terminal 120 of the user who is to make payment. The settlement request may be included in, for example, the two-dimensional code. Further, the communication unit 504 may be configured as a receiving unit (fifth A receiving unit) which receives a completion notification of settlement from the server 110.

The generating unit 506 assists generation of the two-dimensional code to be displayed at the terminal 120 of the user who is to make payment. Specifically, the generating unit 506 instructs the display control unit 508 to display an auxiliary screen for generating the two-dimensional code on a display screen. The auxiliary screen includes, for example, an entry field of a payment amount, and a field for selecting whether or not a bill is split. The generating unit 506 generates the two-dimensional code for bill splitting on the basis of information input on the auxiliary screen via the input/output unit 502. The two-dimensional code for bill splitting will be also referred to as a first information code.

The display control unit 508 controls display on the display screen of the terminal 120. For example, the display control unit 508 performs control to display the auxiliary screen instructed by the generating unit 506 on the display screen or performs control to display the two-dimensional code generated by the generating unit 506 on the display screen. Further, the display control unit 508 performs control to display an adjustment screen instructed by the adjusting unit 512 which will be described later on the display screen. Note that the auxiliary screen and the adjustment screen may be implemented as the whole screen of the display screen or may be implemented as part of a user interface on the display screen.

The acquiring unit 510 acquires the split amount of the bill calculated using the total number of users who are to split a bill based on the respective pieces of account information and at least part of the payment amount on the basis of the settlement pre-processing processed by the server 110 which has received the account information transmitted by the respective terminals 120 which have scanned the two-dimensional code.

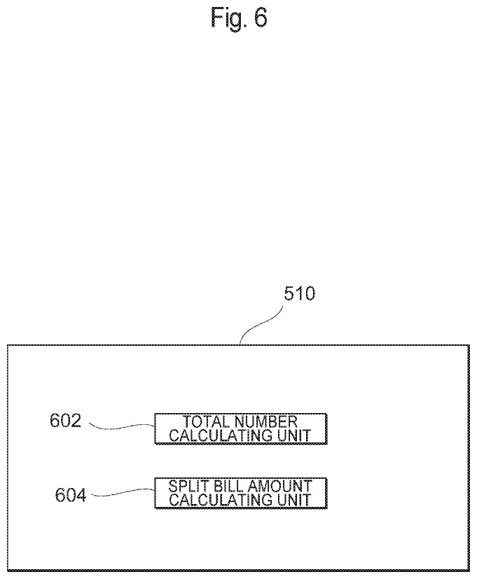

FIG. 6 is a block diagram illustrating an example of a configuration of the acquiring unit 510 according to the first embodiment. As illustrated in FIG. 6, the acquiring unit 510 includes, but not limited to, a total number calculating unit 602 and a split bill amount calculating unit 604.

The total number calculating unit 602 calculates the total number of users who are to split a bill on the basis of the number of pieces of the acquired account information. For example, in a case where the number of pieces of the acquired account information is three, the total number calculating unit 602 calculates the total number (4) by adding the number (1) of the user who is to make payment to the number (3) of the pieces of the account information.

The split bill amount calculating unit 604 calculates the split amount of a bill using the total number calculated by the total number calculating unit 602 and at least part of the payment amount input within the auxiliary screen at the generating unit 506. For example, in a case where the payment amount is 12,000 yens, and the total number is four, the split bill amount calculating unit 604 calculates the split amount of the bill (3,000 yens) by dividing the payment amount (12,000 yens) by the total number (4). Note that, in a case where the split amount of the bill is calculated by the settlement pre-processing unit 306, the acquiring unit 510 acquires the split amount of the bill calculated on the server 110 side.

Returning to FIG. 5, the adjusting unit 512 instructs the display control unit 508 to display the adjustment screen for adjusting the number of persons who are to split the bill on the display screen. The adjusting unit 512 allows adjustment of the number of persons who are to split the bill by, for example, using a plus button and a minus button. By this means, for example, in a case where a user who does not have the terminal 120 is included in persons who are to split the bill, it is possible to include this user in the users who are to split the bill. Further, it is possible to reduce the number of persons from the total number of users who are to split the bill to exclude a user who is erroneously included in the persons who are to split the bill from the users who are to split the bill.

The settlement control unit 514 controls execution of settlement processing and/or bill splitting processing. As a non-limitative example, the settlement control unit 514 instructs the communication unit 504 to transmit a request for account authentication and balance confirmation of the respective users who are to split the bill to the server 110. In this case, the settlement control unit 514 may include the split amount of the bill acquired at the acquiring unit 510 and the account information (the user ID and the password) of the respective users who are to split the bill in the request for balance confirmation.

Further, when the settlement control unit 514 acquires a result of balance confirmation from the server 110, in a case where balance of a predetermined user is less than the split amount of the bill, the settlement control unit 514 stops bill splitting processing or instructs the display control unit 508 to issue an alarm on the display screen. Further, in a case where the result of balance confirmation indicates that balance of all the users who are to split the bill is equal to or greater than the split amount of the bill, the settlement control unit 514 instructs the display control unit 508 to display a two-dimensional code including the payment amount on the display screen. Further, the two-dimensional code may include a user ID of the user who is to make payment. The two-dimensional code for settlement will be also referred to as a second information code.

The scanning unit 516 includes a reader which scans a two-dimensional code. For example, the scanning unit 516 scans a two-dimensional code posted at a store, a two-dimensional code displayed at the POS terminal 130 or a two-dimensional code displayed on a display screen of the terminal 120. Information scanned by the scanning unit 516 is transmitted to the server 110 or used in various kinds of processing.

The storage unit 518 stores a program to be executed by the terminal 120 according to the first embodiment. This program includes, but not limited to, a program for executing the disclosed bill splitting processing in settlement using a two-dimensional code.

<Operation Processing Upon Settlement which is Performed by Store Scanning Code in First Embodiment>

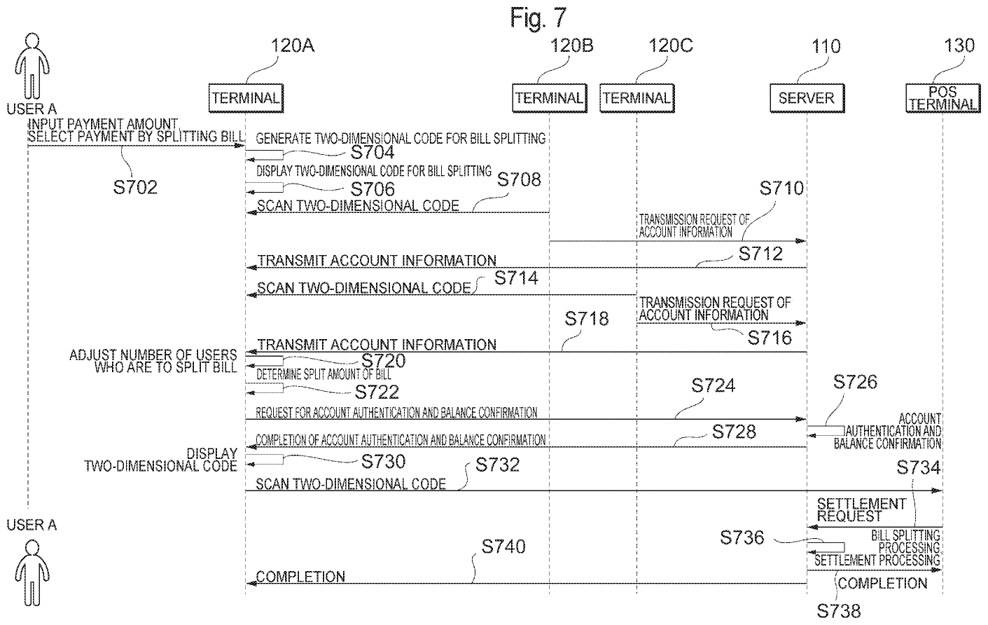

Processing upon settlement which is performed by a store scanning a code in the communication system 1 according to the first embodiment will be described with reference to FIG. 7. FIG. 7 illustrates an example of a sequence of processing procedure upon settlement which is performed by a store scanning a code performed by the communication system 1 according to the first embodiment. An example illustrated in FIG. 7 is a sequence assuming a case where bill splitting processing is performed by the user generating a two-dimensional code (first information code) for performing bill splitting processing and causing each user who is to split a bill to scan the two-dimensional code.

In step S702, the input/output unit 502 of the terminal 120A accepts input of the payment amount and selection of bill splitting processing within the auxiliary screen from the user. For example, the input/output unit 502 accepts input of the payment amount using a soft numerical keypad, or the like, on the display screen by the user or depression of a button for performing bill splitting processing in application for performing settlement using a two-dimensional code.

In step S704, the generating unit 506 of the terminal 120A generates a two-dimensional code for bill splitting on the basis of input of the payment amount and selection of the bill splitting processing by the input/output unit 502. The two-dimensional code for bill splitting includes converted information of the payment amount, a converted user ID, or the like, of the user who is to make payment and who utilizes the terminal 120A. Further, the two-dimensional code may include converted information indicating that bill splitting processing is to be executed. By this means, each terminal 120 which has scanned this two-dimensional code can quickly recognize the bill splitting processing.

In step S706, the display control unit 508 of the terminal 120A performs control to display the two-dimensional code generated by the generating unit 506 on the display screen.

In step S708, the scanning unit 516 of the terminal 120B scans the two-dimensional code displayed at the terminal 120A.

In step S710, the communication unit 504 of the terminal 120B transmits a transmission request for transmitting account information of the user B of the terminal 120B to the terminal 120A, to the server 110. For example, the transmission request includes account information input by the user B who utilizes the terminal 120B and a user ID of the user A who utilizes the terminal 120A.

In step S712, the communication unit 304 of the server 110 transmits the account information of the user B to the terminal 120A. The server 110 can, for example, specify the terminal 120A which is a transmission destination of the account information on the basis of the user ID of the user A.

In step S714, the scanning unit 516 of the terminal 120C scans the two-dimensional code displayed at the terminal 120A.

In step S716, the communication unit 504 of the terminal 120C transmits a transmission request for transmitting account information of the user C of the terminal 120C to the terminal 120A, to the server 110. For example, the transmission request includes the account information input by the user C who utilizes the terminal 120C and the user ID of the user A who utilizes the terminal 120A.

In step S718, the communication unit 304 of the server 110 transmits the account information of the user C to the terminal 120A. The server 110 can, for example, specify the terminal 120A which is a transmission destination of the account information on the basis of the user ID of the user A.

In step S720, the adjusting unit 512 of the terminal 120A adjusts the total number of persons who are to split a bill calculated by the total number calculating unit 602. For example, the total number calculating unit 602 specifies that there are two users who are to split a bill from the received two pieces of account information and specifies that the total number is three by adding one user who is to make payment to the two users. Then, the adjusting unit 512 acquires an adjustment instruction from the user for the total number input by the input/output unit 502. For example, if the user depresses a button of “+” once, the adjusting unit 512 increments the total number by one, and if the user depresses a button of “−” once, the adjusting unit 512 decrements the total number by one. Further, the adjusting unit 512 may adjust an amount which is to be paid by each user. By this means, it is possible to split a bill more flexibly. Note that, while the adjusting unit 512 is not necessarily an essential configuration, by this processing being provided, it becomes possible to adjust the total number of persons who are to split a bill in a case where there is a user who desires to make payment with cash, or the like. Further, the split amount of a bill may be set for each user by the user A who uses the terminal 120A.

In step S722, the acquiring unit 510 of the terminal 120A determines the split amount of a bill. For example, the split bill amount calculating unit 604 of the acquiring unit 510 calculates the payment amount by dividing the payment amount input in step S702 by the total number determined by the total number calculating unit 602 or the total number adjusted by the adjusting unit 512.

In step S724, the communication unit 504 of the terminal 120A transmits a request for account authentication and balance confirmation of the user B and the user C who are to split a bill to the server 110. The request for account authentication and balance confirmation includes, but not limited to, account information of the users who are to split a bill and the split amount of a bill.

In step S726, the settlement pre-processing unit 306 of the server 110 performs account authentication and balance confirmation of the users who are to split a bill. Concerning the account authentication, the settlement pre-processing unit 306 of the server 110 determines whether or not the user ID and the password included in the received account information matches the user ID and the password registered in the user management DB. In a case where the user ID and the password included in the account information matches the user ID and the password registered in the user management DB, it is indicated that authentication is successful, and, in a case where the user ID and the password included in the account information does not match the user ID and the password registered in the user management DB, it is indicated that authentication is failed.

Further, concerning the balance confirmation, the settlement pre-processing unit 306 of the server 110 determines whether or not balance of the respective users who are to split a bill held in the user management DB is equal to or greater than the received split amount of the bill. If the balance is equal to or greater than the split amount of the bill, it is indicated that balance is left, and, if the balance is less than the split amount of the bill, it is indicated that balance is insufficient (no balance is left).

In step S728, the communication unit 304 of the server 110 transmits a result of account authentication and balance confirmation to the terminal 120A. The result of account authentication and balance confirmation includes, for example, success or failure of account authentication, and whether or not balance is left.

In step S730, the settlement control unit 514 of the terminal 120A instructs the display control unit 508 to display a two-dimensional code (second information code) for settlement on the display screen if the result of account authentication and balance confirmation indicates that account authentication is successful and balance is left. By this means, the two-dimensional code is displayed on the display screen. The two-dimensional code may include, for example, a payment amount, a user ID of the user A, or the like.

In step S732, the POS terminal 130 scans the two-dimensional code displayed on the display screen of the terminal 120A.

In step S734, the POS terminal 130 transmits a settlement request including the payment amount, the user ID of the user A, the store ID, or the like, to the server 110.

In step S736, the bill splitting processing unit 308 and the settlement processing unit 310 of the server 110 executes bill splitting processing and settlement processing. For example, the bill splitting processing unit 308 subtracts the split amount of bill from the balance of the user B and the user C who are to split the bill and adds the withdrawn amount to the balance of the user A who is to make payment. The settlement processing unit 310 then withdraws the payment amount from the balance of the user A, and pays the withdrawn payment amount to an account of the store registered in the external system 140 (not illustrated in FIG. 7). It is also possible to employ a configuration where the split amount of the bill is subtracted from the balance of the user A who is to make payment and the balance of the user B and the user C who are to split the bill, and paid to the account of the store registered in the external system 140 (not illustrated in FIG. 7).

In step S738, the communication unit 304 of the server 110 transmits a completion notification to the POS terminal 130 after the bill splitting processing and the settlement processing are completed.

In step S740, the communication unit 304 of the server 110 transmits a completion notification to the POS terminal 130 after the bill splitting processing and the settlement processing are completed.

Note that account authentication of the users who are to split the bill may be performed after step S710 or step S716. In this case, in step S712 and S718, a result of account authentication is transmitted to the terminal 120A. Further, in this case, in step S724, S726 and S728, processing relating to account authentication is not performed. By this means, as a result of account authentication processing being performed in an initial stage of the bill splitting processing, it is possible to exclude a user for whom an account cannot be authenticated from bill splitting processing in settlement application early.

Further, the two-dimensional codes displayed in step S704 and step S730 may be the same two-dimensional code. By this means, it is possible to omit processing of generating a two-dimensional code again. The same two-dimensional code includes the user ID of the user A and the payment amount and may further include a settlement ID for identifying settlement. As a result of the settlement ID being included in the two-dimensional code, the server 110 side can consistently manage account authentication of the users who are to split the bill, the balance confirmation, the bill splitting processing and the settlement processing in association with the settlement ID.

Further, the two-dimensional codes displayed in step S704 and step S730 may be different two-dimensional codes. By this means, it is possible to clearly separate a two-dimensional code for bill splitting from a two-dimensional code for settlement. Further, it is possible to improve security by employing one-time characteristics of the two-dimensional code.

Further, in step S710 and S716, the payment amount may be transmitted to the server 110, in which case, it is possible to calculate the split amount of the bill on the server 110 side. For example, the settlement pre-processing unit 306 of the server 110 calculates a total number of users who are to split the bill on the basis of the number of transmission requests received within a predetermined period, and calculates the split amount of the bill by dividing the payment amount by the total number. The communication unit 304 of the server 110 transmits the split amount of the bill to the terminal 120A. The acquiring unit 510 of the terminal 120A acquires the split amount of the bill calculated on the basis of settlement pre-processing processed by the server 110. By this means, it is possible to reduce processing on an application side of the terminal 120A.

Note that, while the payment amount is input by the user in step S702, the payment amount may be input by the two-dimensional code of the POS terminal 130, or the like, being scanned. By this means, it is possible to prevent the payment amount from being erroneously input by the user.

<Display Aspect Upon Settlement which is Performed by Store Scanning Code Regarding Terminal in First Embodiment>

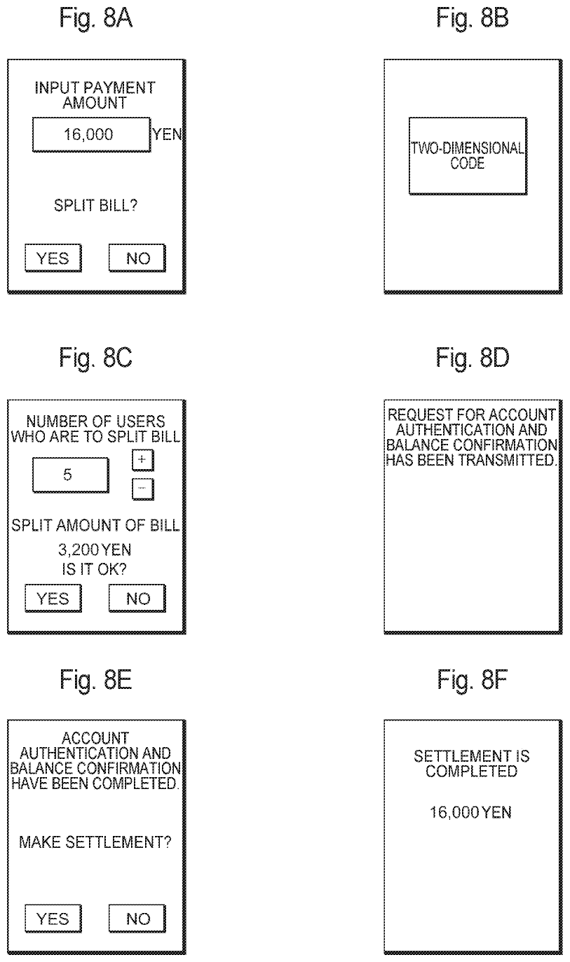

FIG. 8 illustrates an example of a screen to be displayed at the terminal 120 according to the first embodiment. FIG. 8A illustrates an example of an auxiliary screen for generating a two-dimensional code. The auxiliary screen illustrated in FIG. 8A includes at least an entry field for the payment amount and a selection button for bill splitting. The auxiliary screen illustrated in FIG. 8A corresponds to, for example, a screen displayed in processing in step S702 illustrated in FIG. 7.

FIG. 8B illustrates an example of a screen for displaying the generated two-dimensional code. The screen illustrated in FIG. 8B includes the two-dimensional code generated by the generating unit 506 of the terminal 120. The screen illustrated in FIG. 8B, for example, corresponds to a screen displayed in the processing in step S706 illustrated in FIG. 7.

FIG. 8C illustrates an example of a screen for adjusting the total number of users who are to split a bill. The screen illustrated in FIG. 8C includes a button for increasing or decreasing the total number of users who are to split the bill, a display field for the split amount of the bill, and a button for confirming the split amount of the bill. The split amount of the bill is changed through processing by the acquiring unit 510, or the like, in accordance with increase or decrease of the total number of users who are to split the bill. The screen illustrated in FIG. 8C, for example, corresponds to a screen displayed in the processing in step S720 illustrated in FIG. 7. If the user depresses a “Yes” button on the screen illustrated in FIG. 8C, the processing in step S724 is performed.

FIG. 8D illustrates that a request for account authentication and balance confirmation of the users who are to split the bill has been transmitted. The screen illustrated in FIG. 8D may be displayed on the display screen of the terminal 120A until the result in step S728 is received or until predetermined time has elapsed after the processing in step S724 illustrated in FIG. 7 is performed.

FIG. 8E illustrates that account authentication and balance confirmation of the users who are to split the bill have been completed. The screen illustrated in FIG. 8E is displayed in a case where account authentication of all the users who are to split the bill is successful, and the balance equal to or greater than the split amount of the bill is left. The screen illustrated in FIG. 8E may be displayed on the display screen of the terminal 120 after the processing in step S728 illustrated in FIG. 7 is performed.

FIG. 8F illustrates that settlement has been completed. The screen illustrated in FIG. 8F includes, for example, display of the payment amount and completion of settlement. The screen illustrated in FIG. 8F may be displayed on the display screen of the terminal 120 after the processing in step S740 illustrated in FIG. 7 is performed.

### <<First A Example>>

A first A example of the first embodiment is an example where it is determined whether there is predetermined relationship between the users who are to split the bill and the user who is to make payment, and, in a case where there is no predetermined relationship, bill splitting processing is not performed. A state where “there is predetermined relationship” is, for example, determined on the condition that the users who are to split the bill and the user who is to make payment are within a predetermined group such as friends, university and family.

### <<Effects of the First A Example>>

According to the present example, because it is determined whether there is predetermined relationship between the user who is to make payment and the users who are to split the bill, it is possible to prevent bill splitting processing from being performed on a user who has no relationship with the user who is to make payment.

### <<Operation Processing of the First A Example>>

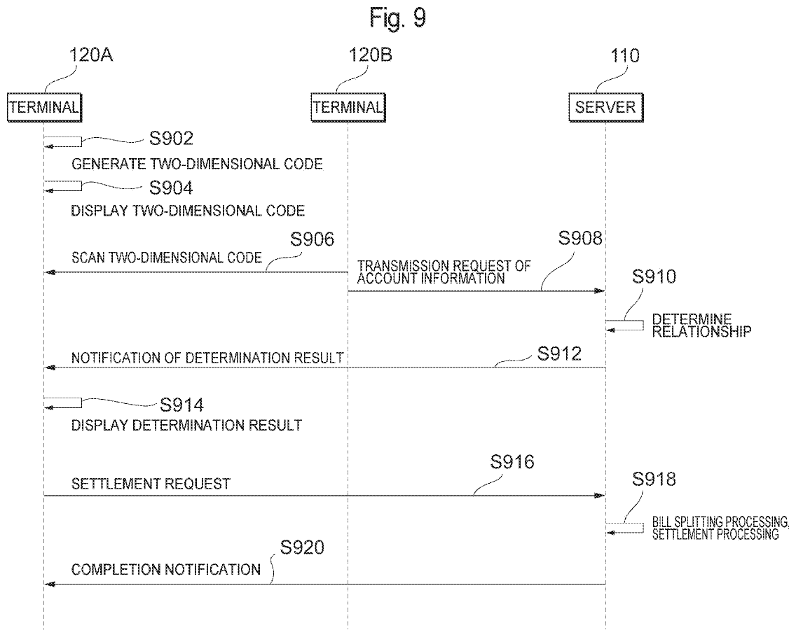

FIG. 9 illustrates an example of a sequence of processing of the server 110 and the terminal 120 according to the present example. The example illustrated in FIG. 9 is a sequence assuming a case where, after the user generates a two-dimensional code for performing bill splitting processing and causes the terminal 120 of each of the users who are to split the bill to scan the two-dimensional code, the server 110 determines whether or not there is predetermined relationship between the users, and, in a case where there is predetermined relationship, bill splitting processing is performed.

Because processing in step S902, S904, S906 and S908 illustrated in FIG. 9 is respectively similar to processing in step S704, S706, S708 and S710 illustrated in FIG. 7, description will be omitted. Note that, in step S902, the generating unit 506 may generate a two-dimensional code including a payment amount and a store ID from a settlement screen of online shopping, or the like.

In step S910 illustrated in FIG. 9, the settlement pre-processing unit 306 of the server 110 determines whether or not there is predetermined relationship between users. For example, the settlement pre-processing unit 306 makes an inquiry to the relation management DB as to whether or not there is predetermined relationship between the user who is to make payment and the users who are to split the bill. Specifically, the settlement pre-processing unit 306 determines whether or not a user ID of the user who is to make payment and user IDs of the users who are to split the bill are included in the same group within the relation management DB. If the both IDs are included within the same group, it is determined as “there is relationship”, and if the both IDs are not included within the same group, it is determined as “there is no relationship”.

In step S912, the communication unit 304 of the server 110 transmits a determination result regarding the predetermined relationship to the terminal 120A.

In step S914, the display control unit 508 of the terminal 120A performs control to display the determination result received from the server 110 on the display screen. For example, in a case where there is predetermined relationship between a first user who utilizes the terminal 120A and other respective users who utilize respective information processing devices, on the display screen, at least part of information of the users who have this predetermined relationship is displayed in an aspect different from that of at least part of information of the users who do not have predetermined relationship. As a non-limitative example, at least one of color of characters, a character size, font of characters, or the like, is made different between user IDs of the users who have predetermined relationship and user IDs of the users who do not have predetermined relationship. Further, as another example, “there is relationship” or “there is no relationship” may be displayed on the display screen in association with user information.

In step S916, the settlement control unit 514 of the terminal 120A transmits a settlement request to the server 110. The settlement request includes a user ID of the user who is to make payment, user IDs of the users who are to split the bill and the payment amount.

In step S918, the bill splitting processing unit 308 and the settlement processing unit 310 of the server 110 perform the above-described bill splitting processing and settlement processing. Note that, because the bill splitting processing unit 308 knows the total number of users who are to split the bill and the payment amount, the bill splitting processing unit 308 may calculate the split amount of the bill.

In step S920, the server 110 transmits a completion notification of the bill splitting processing and/or the settlement processing to the terminal 110A.

While, in the bill splitting processing illustrated in FIG. 9, simple bill splitting processing in which account authentication and balance confirmation are not performed is illustrated, the account authentication and the balance confirmation described in FIG. 7 may be performed. Further, after step S916, the terminal 120A may perform control to display a two-dimensional code (second information code) for settlement on the display screen and may transmit a settlement request through the POS terminal 130, or the like, which has scanned this two-dimensional code. Further, while, in the example illustrated in FIG. 9, the server 110 stores the relation management DB, the relation management DB may be stored at each terminal. In this case, each terminal may receive account information of other terminals from the server 110 and may determine whether or not there is predetermined relationship at the own terminal on the basis of the account information of other terminals.

### <<Second A Example>>

A second A example of the first embodiment can be also applied to processing (hereinafter, also referred to as “representative payment processing”) in which the other person who has predetermined relationship with a user who should make payment makes payment on behalf of the user who should make payment instead of splitting the bill. For example, in a case where a two-dimensional code is displayed on a display screen of the terminal 120 which is used by a child, the terminal 120 of a parent scans the displayed two-dimensional code, and parent-child relationship is approved, the parent performs representative payment processing on behalf of the child.

### <<Effects of Second A Example>>

According to the present example, the user who has predetermined relationship with the user who should make payment can pay a full amount of the payment amount on behalf of the user who should make payment.

### <<Operation Processing of Second A Example>>

The present example will be described using the sequence illustrated in FIG. 9, for example, assuming that a terminal 120A is a terminal of a child, and a terminal 120B is a terminal of a parent. In step S902, the generating unit 506 of the terminal 120A generates a two-dimensional code for representative payment.

In step S912, S914, S916 and S920, a processing target is changed from the terminal 120A of the child to the terminal 120B of the parent. Further, in step S918, bill splitting processing is not executed, and settlement processing is executed. By this means, a full amount of the payment amount is drawn from an account of the parent, and paid to an account, or the like, on a store side. Further, it is also possible to employ a configuration where the terminal 120A of the child or the terminal 120B of the parent causes a two-dimensional code for settlement to be displayed on the display screen, and causes the POS terminal 130, or the like, which has scanned this two-dimensional code to transmit a settlement request.

### <<Third A Example>>

In a third A example of the first embodiment, when the payment amount cannot be divided evenly by the total number of users who are to split the bill, rounding processing is performed on the split amount of the bill of each user who is to split the bill. The rounding processing is processing in which to whom and how a remainder portion after the decimal point which cannot divided evenly is allocated, or the like, is determined.

### <<Effects of Third A Example>>

According to the third A example, because, when the split amount of the bill is calculated, processing for a portion after the decimal point which cannot be divided evenly is set, it is possible to appropriately execute bill splitting processing for an arbitrary payment amount and an arbitrary total number of users who are to split the bill.

The rounding processing is executed by the settlement pre-processing unit 306 of the server 110, the acquiring unit 510 of the terminal 120, or the like. Further, the rounding processing may include several types of rounding processing, and, in a case where the payment amount cannot be divided evenly by the total number, one type of rounding processing may be determined in advance, or the user may be allowed to determine one from the several types of processing. Note that the rounding processing can be applied to the embodiments or the examples which have been described above or which will be described later.

### (Rounding Processing 1)

In rounding processing 1, the split amount of the bill of each user is determined by rounding up or rounding down a division result (quotient) of each user. For example, it is assumed that the payment amount is 10,000 yen, and the total number of users who are to split the bill is three. In this case, if a remainder (after the decimal point) of the quotient of the split amount of the bill is rounded off, the split amount of the bill per person is 3,333 yen, the total of the split amount of the bill is one yen short from the payment amount. Therefore, among the three users who are to split the bill, the amount after the decimal point is rounded down for two users, and the amount after the decimal point is rounded up for one user. In the rounding processing, one user who is to split the bill for whom the amount after the decimal point is rounded up is determined in accordance with predetermined conditions. For example, as the user for whom the amount after the decimal point is rounded up, the user who is to make payment may be set in advance, or a user whose account information has been received at the server first may be set, or the user who is to make payment may determine the user.

### (Rounding Processing 2)

Rounding processing 2 includes processing of determining the split amount of the bill of each user by rounding down the quotient of each user who is to split the bill. The server 110 executes processing of discounting from the payment amount, an amount obtained by subtracting a total of the split amounts of the bill of the respective users who are to split the bill from the payment amount. For example, it is assumed that the payment amount is 10,000 yen, and the total number of users who are to split the bill is three. In this case, while, if a remainder of the quotient of the split amount of the bill is rounded down, the split amount of bill per person is 3,333 yen, a total of the split amounts of the bill is one yen short from the payment amount. In the rounding processing 2, the server 110 executes processing of discounting one yen from the payment amount. Note that a deficit resulting from the remainder being rounded down may be covered by a settlement service provider or a store.

### (Rounding Processing 3)

Rounding processing 3 includes processing of determining the split amount of the bill of each user who is to split the bill by rounding up a quotient of each user who is to split the bill. The server 110 executes processing of paying an amount obtained by subtracting the payment amount from the total of the split amounts of the bill of the respective users who are to split the bill, to the settlement service provider. For example, it is assumed that the payment amount is 10,000 yen, and the total number of users who are to split the bill is three. In this case, while, if the remainder of the quotient of the split amount of the bill is rounded up, the split amount of the bill per person is 3,334 yen, the total of the split amounts of the bill is more than the payment amount by two yen. In the rounding processing 3, the server 110 executes processing of paying two yen by which the total of the split amounts of the bill is more than the payment amount to the settlement service provider. In the rounding processing 1 to 3 described above, a digit at which the quotient is rounded down or up may be a unit digit or a tens digit as well as a digit after the decimal point.

(B) Configuration of Terminal in Settlement which is Performed by User Scanning Code

A configuration of a terminal in settlement which is performed by a user scanning a code will be described next. In a case where the configuration of the terminal in settlement which is performed by the user scanning a code is similar to the configuration of the terminal in settlement which is performed by a store scanning a code, description will be omitted below.

The communication unit 504 may be configured as a transmitting unit (fourth B transmitting unit) which transmits settlement information included in a two-dimensional code associated with a store (for example, a two-dimensional code posted at a store or a two-dimensional code displayed at a terminal provided at a store), account information of a user who utilizes the own terminal 120, or the like, to the server 110. The settlement information includes, but not limited to, at least a store ID, and may further include a payment amount. For example, the settlement information includes a store ID in a case where the two-dimensional code is used for table check-in, or the like, and includes a store ID and a payment amount in a case where the two-dimensional code is used for payment using the POS terminal 130, or the like. The account information includes, but not limited to, user IDs and passwords of users who are to split a bill, and who utilize the terminals 120 which have scanned the two-dimensional code.

Further, the communication unit 504 may be configured as a receiving unit (fourth B receiving unit) which receives the split amount of the bill obtained by dividing the payment amount associated with the settlement information using the total number of pieces of the account information on the basis of settlement pre-processing processed by the server 110 which has received the account information transmitted by the respective terminals 120 which have scanned the two-dimensional code. The settlement pre-processing unit 306 of the server 110 can calculate the split amount of the bill using a total number of pieces of the received account information and the payment amount.

Further, the communication unit 504 may be configured as a transmitting unit (fifth B transmitting unit) which transmits a settlement request including the split amount of the bill to the server 110. Further, the settlement request may include a store ID.

Further, the communication unit 504 may be configured as a receiving unit (fifth B receiving unit) which receives a completion notification of settlement from the server 110.

The acquiring unit 510 acquires the split amount of the bill obtained by dividing the payment amount associated with the settlement information using the total number of users who are to split the bill based on the respective pieces of account information on the basis of settlement pre-processing processed by the server 110 which has received the account information transmitted by the respective terminals 120 which have scanned the two-dimensional code. Note that the acquiring unit 510 may acquire the split amount of the bill received from the server 110 or may calculate the split amount of the bill by dividing the payment amount by the acquired total number of accounts in a similar manner to the settlement which is performed by a store scanning a code.

The scanning unit 516 scans a two-dimensional code associated with a store (for example, a two-dimensional code posted at a store or a two-dimensional code displayed at a terminal provided at a store). Information scanned using the scanning unit 516 is transmitted to the server 110 or used for various kinds of processing.

<Operation Processing Upon Settlement which is Performed by User Scanning Code in First Embodiment>

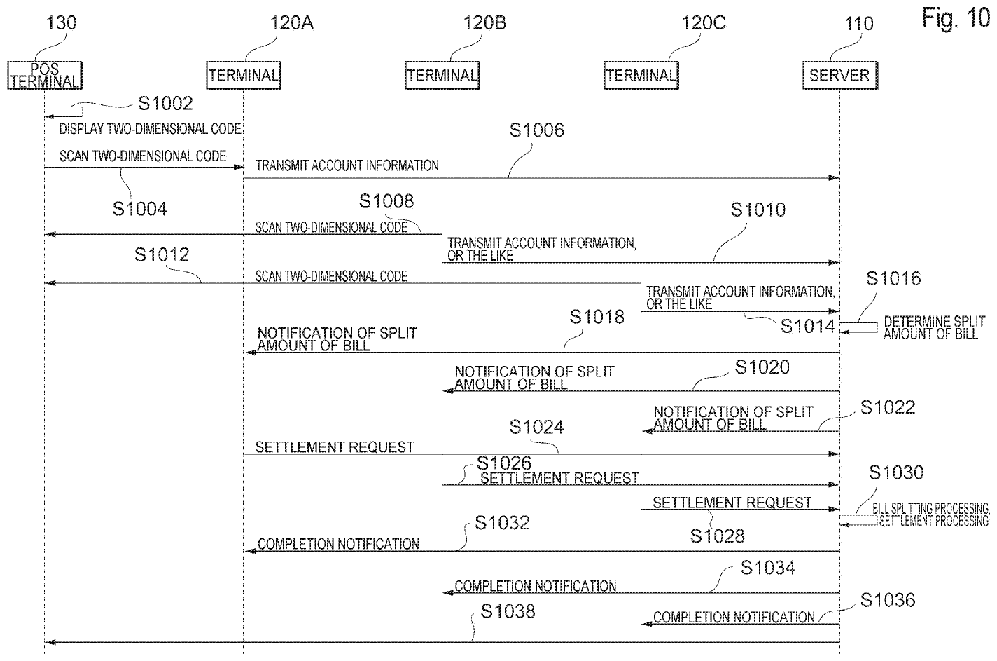

Processing upon settlement which is performed by a user scanning a code in the communication system 1 according to the first embodiment will be described with reference to FIG. 10. FIG. 10 illustrates an example of a sequence of processing procedure upon settlement which is performed by a user scanning a code, performed by the communication system 1 according to the first embodiment. The example illustrated in FIG. 10 is a sequence assuming a case where bill splitting processing is performed by a two-dimensional code displayed at the POS terminal 130 being scanned by respective terminals 120 which are utilized by the respective users who are to split the bill.

In step S1002, the POS terminal 130 displays a two-dimensional code for settlement on the display screen. This two-dimensional code includes, but not limited to, information such as a payment amount and a store ID, which is converted. Note that the payment amount may be input by the user.

In step S1004, the scanning unit 516 of the terminal 120A scans the two-dimensional code displayed at the POS terminal 130.

In step S1006, the communication unit 504 of the terminal 120A transmits account information of the user A of the terminal 120A, the payment amount scanned from the two-dimensional code or input by the user, the store ID, or the like, to the server 110.

In step S1008, the scanning unit 516 of the terminal 120B scans the two-dimensional code displayed at the POS terminal 130.

In step S1010, the communication unit 504 of the terminal 120B transmits account information of the user B of the terminal 120B, the payment amount, the store ID, or the like, scanned from the two-dimensional code, to the server 110.

In step S1012, the scanning unit 516 of the terminal 120C scans the two-dimensional code displayed at the POS terminal 130.

In step S1014, the communication unit 504 of the terminal 120C transmits account information of the user C of the terminal 120C, the payment amount, the store ID, or the like, scanned from the two-dimensional code, to the server 110.

In step S1016, the settlement pre-processing unit 306 of the server 110, for example, counts the total number of pieces of account information transmitted along with the same store ID and the same payment amount within a predetermined time period. Further, the settlement pre-processing unit 306 of the server 110 calculates the split amount of the bill by dividing the payment amount by the total number. Note that account authentication may be performed on the server 110 side at this time point. Further, in a case where there is a user for whom account authentication has been failed, the server 110 may request the user to input the account information again. At this time, the server 110 may extend the predetermined time period for collecting users who are to split the bill.

Further, the settlement pre-processing unit 306 of the server 110 may perform balance confirmation processing with reference to balance of accounts of the respective users who are to split the bill after calculating the split amount of the bill. In this case, the respective users who are to split the bill are notified of results of balance confirmation processing for the respective users who are to split the bill.

In step S1018, the communication unit 304 of the server 110 notifies the terminal 120A of the calculated split amount of the bill.

In step S1020, the communication unit 304 of the server 110 notifies the terminal 120B of the calculated split amount of the bill.

In step S1022, the communication unit 304 of the server 110 notifies the terminal 120C of the calculated split amount of the bill.

In step S1024, after the display control unit 508 of the terminal 120A performs control to display the split amount of the bill, the settlement control unit 514 of the terminal 120A instructs the communication unit 504 to transmit a settlement request to the server 110.

In step S1026, after the display control unit 508 of the terminal 120B performs control to display the split amount of the bill, the settlement control unit 514 of the terminal 120B instructs the communication unit 504 to transmit a settlement request to the server 110.

In step S1028, after the display control unit 508 of the terminal 120C performs control to display the split amount of the bill, the settlement control unit 514 of the terminal 120C instructs the communication unit 504 to transmit a settlement request to the server 110.

In step S1030, the bill splitting processing unit 308 of the server 110 withdraws the split amounts of the bill from respective pieces of balance associated with accounts of the respective users who are to split the bill in response to the settlement request. The settlement processing unit 310 then executes processing of paying the total amount (payment amount) of the respective withdrawn split amounts of the bill to a side of the store indicated with the store ID associated with the settlement information. Note that the bill splitting processing unit 308 may be included in the settlement processing unit 310, in which case, the settlement processing unit 310 may withdraw the split amounts of the bill from balance of the users A, B and C and may pay a total (payment amount) of the withdrawn split amounts of the bill to an account of the store registered in the external system 140 (not illustrated in FIG. 7).

In step S1032, the communication unit 304 of the server 110 transmits a completion notification to the terminal 120A after bill splitting processing or settlement processing has been completed.

In step S1034, the communication unit 304 of the server 110 transmits a completion notification to the terminal 120B after bill splitting processing or settlement processing has been completed.

In step S1036, the communication unit 304 of the server 110 transmits a completion notification to the terminal 120C after bill splitting processing or settlement processing has been completed.

In step S1038, the communication unit 304 of the server 110 transmits a completion notification to the POS terminal 130 after bill splitting processing or settlement processing has been completed.

### <<First B Example>>

A first B example of the first embodiment is an example where the users who are to split the bill scan the two-dimensional code in advance to check in, and make payment by bill splitting processing being performed after the payment amount is determined. As a specific example of the first B example, a two-dimensional code posted on a table at a restaurant, or the like, or a two-dimensional code displayed at a terminal provided at a table is scanned with the terminals 120 of respective users (respective users who are to split the bill) who are seated at the table, to perform check-in processing. Then, each user orders a meal, or the like, and after all the order is fixed, a payment amount is determined. Thereafter, the payment amount is transmitted from the terminal of the table or a register terminal of a store to a server, and the server executes bill splitting processing and settlement processing. If the payment amount is associated with a settlement ID, or the like, it becomes easy to associate the payment amount with settlement information transmitted in advance.

### <<Effects of First B Example>>

According to the present example, because the total number of users who are to split the bill is counted in advance, and account authentication processing, or the like, of each user who is to split the bill can be performed in advance, it becomes possible to promptly complete processing when the bill is split. For example, at a restaurant, when the user is seated at a table, or the like, check-in is completed by each terminal 120 scanning a two-dimensional code, and counting of the total number of users who are to split the bill and account authentication are completed on the server 110 side before order is completed, so that it is possible to quickly execute bill splitting processing and settlement processing after a payment amount is determined. Further, because the user can perform check-out processing at the table, the user can leave the restaurant without going to a cash register.

### <<Operation Processing of First B Example>>

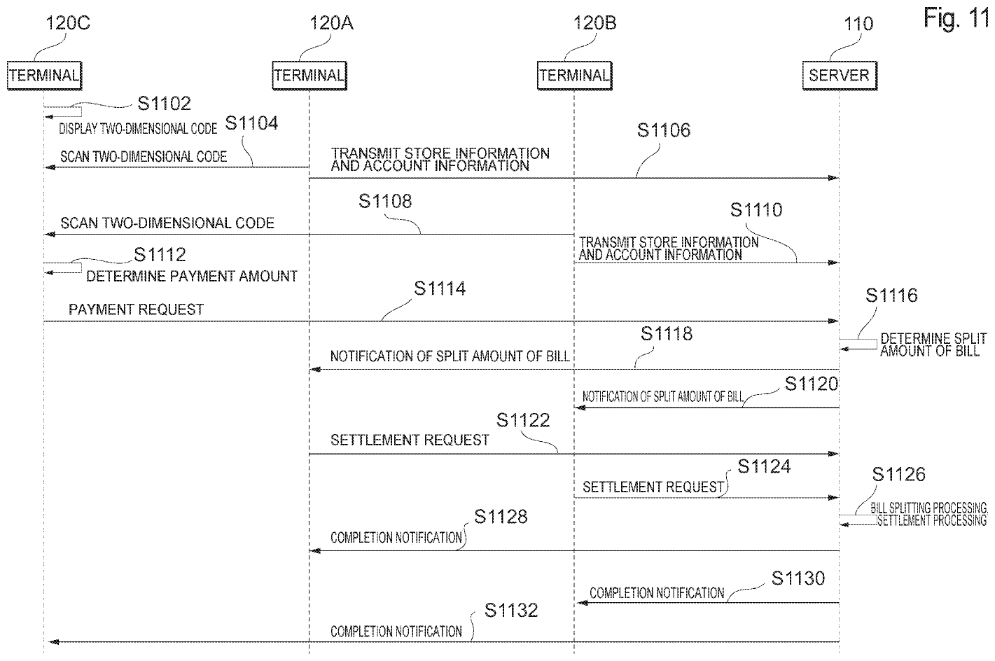

FIG. 11 illustrates an example of a sequence of processing of the communication system 1 according to the present example. The present example will be described using the sequence illustrated in FIG. 11, for example, assuming that the terminal 120C is a terminal provided at a table of a restaurant. A two-dimensional code displayed at this terminal 120C is scanned by the terminal 120A and the terminal 120B of the users to perform check-in processing. Further, each user can order menu, give an instruction of completion of the order, confirm a payment amount or give an instruction of settlement processing using the terminal 120C.

In step S1102, the terminal 120C displays a two-dimensional code for settlement on a display screen. This two-dimensional code includes, but not limited to, a store ID, a table ID, a settlement ID or combination thereof, which are converted. The terminal 120C is, for example, a terminal which is placed on a table, or the like, of a restaurant, and through which orders can be placed.

In step S1104, the scanning unit 516 of the terminal 120A scans the two-dimensional code displayed at the terminal 120C.

In step S1106, the communication unit 504 of the terminal 120A transmits account information of the user A of the terminal 120A, a store ID, or the like, (settlement information) scanned from the two-dimensional code, to the server 110. Note that, at this time point, the server 110 may perform account authentication of the user A. The store ID may play a role as payee identification information in which this store is set as a payee.

In step S1108, the scanning unit 516 of the terminal 120B scans the two-dimensional code displayed at the terminal 120C.

In step S1110, the communication unit 504 of the terminal 120B transmits account information of the user B of the terminal 120B, the store ID, or the like, scanned from the two-dimensional code, to the server 110. Note that, at this time point, the server 110 may perform account authentication of the user B.

In step S1112, the terminal 120C determines the payment amount which is a total amount of the menus ordered by the user A or the user B through depression of a payment button, or the like, by the user A or the user B.

In step S1114, the terminal 120C transmits a payment request to the server 110 through depression of a payment amount confirmation button, or the like, by the user A or the user B. The payment request includes, but not limited to, information of a store ID and the payment amount.

In step S1116, the settlement pre-processing unit 306 of the server 110 counts, for example, the total number of users who have checked in in advance in response to reception of the payment request. Note that the total number of users may be calculated in advance. Further, the settlement pre-processing unit 306 of the server 110 calculates the split amount of the bill by dividing the payment amount by the total number. Note that, at this time point, if account authentication of the user A and/or the user B is not performed, the server 110 may perform account authentication for the user, which has not been executed yet. Further, in a case where there is a user for whom account authentication has been failed, the server 110 may request the user to input account information again.

Further, the settlement pre-processing unit 306 of the server 110 may perform balance confirmation processing with reference to balance of accounts of the respective users who are to split the bill after calculating the split amount of the bill. In this case, the respective users who are to split the bill are notified of results of balance confirmation processing for the respective users who are to split the bill.

In step S1118, the communication unit 304 of the server 110 notifies the terminal 120A of the calculated split amount of the bill.

In step S1120, the communication unit 304 of the server 110 notifies the terminal 120B of the calculated split amount of the bill.

In step S1122, after the display control unit 508 of the terminal 120A performs control to display the split amount of the bill, the settlement control unit 514 of the terminal 120A instructs the communication unit 504 to transmit a settlement request to the server 110.

In step S1124, after the display control unit 508 of the terminal 120B performs control to display the split amount of the bill, the settlement control unit 514 of the terminal 120B instructs the communication unit 504 to transmit a settlement request to the server 110.

In step S1126, the bill splitting processing unit 308 of the server 110 withdraws the split amount of the bill from respective pieces of balance associated with accounts of the respective users who are to split the bill in response to the settlement request. The settlement processing unit 310 then executes processing of paying a total amount (payment amount) of the respective withdrawn split amounts of the bill to a side of the store indicated with the store ID associated with the settlement information. Note that the bill splitting processing unit 308 may be included in the settlement processing unit 310, in which case, the settlement processing unit 310 may withdraw the split amounts of the bill from the balance of the users A and B and pay a total (payment amount) of the withdrawn split amounts of the bill to an account of the store registered in the external system 140 (not illustrated in FIG. 7).

In step S1128, the communication unit 304 of the server 110 transmits a completion notification to the terminal 120A of the user A after bill splitting processing or settlement processing has been completed.

In step S1030, the communication unit 304 of the server 110 transmits a completion notification to the terminal 120B of the user B after bill splitting processing or settlement processing has been completed.

In step S1132, the communication unit 304 of the server 110 transmits a completion notification to the terminal 120C on the store side after bill splitting processing or settlement processing has been completed.

### <<Second B Example>>

In a second B example of the first embodiment, in the first example B, the server 110 may perform bill splitting processing and settlement processing without the users who are to split the bill confirming the split amount of the bill. For example, step S1118 to S1124 may be omitted in the sequence illustrated in FIG. 11.

### <<Effects of Second B Example>>

According to the present example, it is possible to prevent settlement from being forgotten to be done or prevent interruption during settlement processing due to a settlement request being not transmitted from at least one user in check-out processing. Particularly, in a case where there are a number of users who are to split a bill, the second B example is effective.

### Second Embodiment

A second embodiment is an embodiment where, even if users who are to split a bill are users who do not have predetermined relationship on settlement service, a user who is to make payment can select the users who are to split a bill from a list of candidates generated using a distance from the user who is to make payment, so that it is possible to smoothly perform bill splitting processing and expand targets of bill splitting processing.

In the second embodiment, as a non-limitative example, in a case where the terminal 120 accepts a bill splitting request from a first user who utilizes the own terminal 120, a list of candidates for users who are to split a bill generated using a distance from the first user is displayed. The terminal 120 accepts selection of a second user who is to actually split a bill from the list of candidates. The terminal 120 of the first user transmits a confirmation request as to whether bill splitting processing may be performed for the terminal 120 of the selected second user and receives a confirmation result from the terminal 120 to which the confirmation request has been transmitted. If bill splitting processing is allowed by the second user, the terminal 120 of the first user transmits a settlement request to the server 110 so that bill splitting processing and settlement processing are executed, and, in a case where settlement has been completed, the terminal 120 of the first user receives a completion notification of the settlement.

### <Effects of Second Embodiment>

According to the second embodiment, even for users who do not have predetermined relationship with a user who is to make payment, because a list of candidates generated using a distance with the user who is to make payment is received, the users who are to split a bill are selected on the spot, so that it is possible to settle the split amount of the bill from accounts of the selected users who are to split the bill. For example, because a party organizer of a drinking party can easily select members to whom the party organizer has met for the first time at the drinking party from a list of candidates, it is possible to smoothly execute bill splitting processing and settlement processing.

### <HW Configuration of Second Embodiment>

### (1) HW Configuration

Because a HW configuration of the server 110, the information processing terminal 120 and the POS terminal 130 in the second embodiment is equal to a HW configuration of the server 110, the information processing terminal 120 and the POS terminal 130 in the first embodiment, detailed description will be omitted here.

### <Configuration of Second Embodiment>

### (1) Configuration of Server

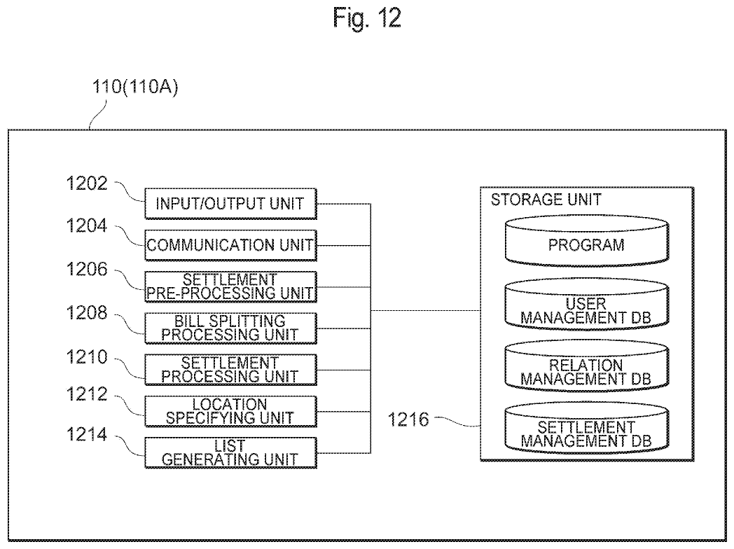

FIG. 12 illustrates an example of a configuration of the server 110 in the second embodiment. Respective units disclosed in FIG. 12 are implemented in coordination with the processor 201, the memory 202, the storage 203, the input/output I/F 204, and the communication I/F 205 provided at the information processing devices 200.

The server 110 includes, for example, an input/output unit 1202, a communication unit 1204, a settlement pre-processing unit 1206, a bill splitting processing unit 1208, a settlement processing unit 1210, a location specifying unit 1212, a list creating unit 1214, and a storage unit 1216. The location specifying unit 1212 and the list creating unit 1214 which are added in the second embodiment are implemented by the processor 201 reading out and executing a program stored in the storage unit 312. Points which are not particularly mentioned in the configuration of the server 110 in the second embodiment may be the same as those in the configuration in the first embodiment.

The communication unit 1204 may be configured as a receiving unit which receives a search request for a list of candidates from the terminal 120. Further, the communication unit 1204 may be configured as a receiving unit which receives location information of each terminal 120. Further, the communication unit 1204 may be configured as a transmitting unit which transmits a list of candidates including a user who is located in the vicinity of the user A, created at the list creating unit 1214, to the terminal 120. Further, the communication unit 1204 may be configured as a receiving unit which receives a near field communication identifier received by the terminal 120 as location information of the terminal 120.

The location specifying unit 1212 specifies a location of each terminal 120 on the basis of the location information of each terminal 120 notified from each terminal 120. For example, the location specifying unit 1212 specifies a location indicated with the location information as a location of a terminal 120A in a case where location information (for example, latitude and longitude) directly indicating the location of the terminal 120A is acquired from the terminal 120A.

The list creating unit 1214 acquires the location information of each terminal 120 specified by the location specifying unit 1212 and a user ID of each terminal 120 and creates a list of candidates for users who are to split a bill. The list of candidates includes user IDs corresponding to the acquired location information, nickname associated with user IDs, or the like. Further, the list creating unit 1214 may generate a list of candidates so that users who utilize terminals 120 closer to the terminal 120A are sequentially displayed from a top on a screen as a non-limitative example. Further, the list creating unit 1214 creates a list of candidates so that a user within the list can be selected. The list creating unit 1214 instructs the communication unit 1204 to transmit the created list of candidates to the terminal 120A which has transmitted the search request. In response to this instruction, the communication unit 1204 transmits the list of candidates to the terminal 120A.

### (2) Configuration of Terminal

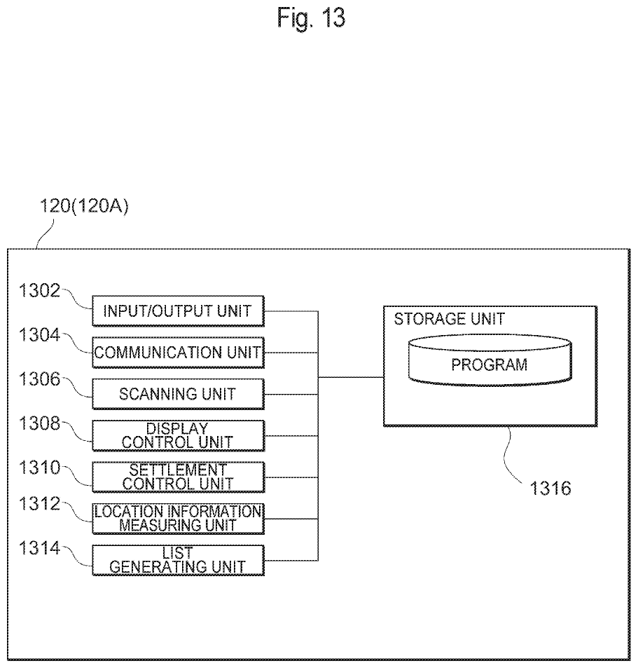

FIG. 13 illustrates an example of a configuration of the terminal 120 in the second embodiment. Respective units disclosed in FIG. 13 are implemented in coordination with the processor 201, the memory 202, the storage 203, the input/output I/F 204, and the communication I/F 205 provided at the information processing devices 200.

The terminal 120 includes an input/output unit 1302, a communication unit 1304, a scanning unit 1306, a display control unit 1308, a settlement control unit 1310, a location information measuring unit 1312, and a list creating unit 1314. The location information measuring unit 1312 and the list creating unit 1314 added in the second embodiment are implemented by the processor 201 reading out and executing a program stored in the storage unit 1316. Note that points which are not particularly mentioned in each configuration of the terminal 120 in the second embodiment may be the same as those in the configuration in the first embodiment.

The communication unit 1304 may be configured as a transmitting unit which transmits location information of the terminal 120 measured at the location information measuring unit 1312. Further, the communication unit 1304 may be configured as a receiving unit which receives a list of candidates from the server 110. Still further, the communication unit 1304 may be configured as a transmitting unit which transmits a radio identifier for establishing near field communication with other terminals 120. The communication unit 1304 may be configured as a receiving unit which receives radio identifiers from other terminals 120. Note that radio identifiers for near field communication may include, but not limited to, a beacon ID included in a beacon transmitted by a BLE (Bluetooth Low Energy) device, an SSID included in a radio signal transmitted by a Wi-Fi (R) device, and arbitrary identification information included in an ultrasonic wave.

The display control unit 1308 displays the list of candidates received at the communication unit 1304 or created at the list creating unit 1314 on a screen. Further, the display control unit 1308 performs control so that users within the list of candidates can be selected.

The location information measuring unit 1312 measures location information of a current location of the terminal 120. The location information measuring unit 1312 measures latitude and longitude of the terminal 120 as the location information of the current location of the terminal 120 using a GPS (Global Positioning System) as a non-limitative example. Note that the location information of the terminal 120 may be measured by the location information measuring unit 1312 using any method if the location information of the terminal 120 can be measured. As a non-limitative example, the location information measuring unit 1312 may measure the location information of the terminal 120 by utilizing near field communication such as IMES (Indoor MEssaging System), Wi-Fi, RFID (Radio Frequency Identifier), NFC (Near Field Communication) and BLE (Bluetooth Low Energy), a mobile communication system such as LTE and CDMA, or the like.

The list creating unit 1314 creates a list of candidates for users who are to split the bill on the basis of the location information with another terminal 120 with which wireless communication is established by the communication unit 1304. The list of candidates includes a user ID corresponding to the acquired radio identifier, nickname associated with a user ID, or the like. Further, the list creating unit 1314 may generate a list of candidates so that users who utilize the terminals 120 closer to the terminal 120A are sequentially displayed from the top on a screen as a non-limitative example. Further, the list creating unit 1314 creates a list of candidates so that users within the list can be selected. The list creating unit 1314 uses signal strength of wireless communication in judgment of closeness between the terminals 120. For example, the list creating unit 1314 can judge that the terminals are closer to each other as signal strength of the established wireless communication is greater.

### <Operation Processing of Second Embodiment>

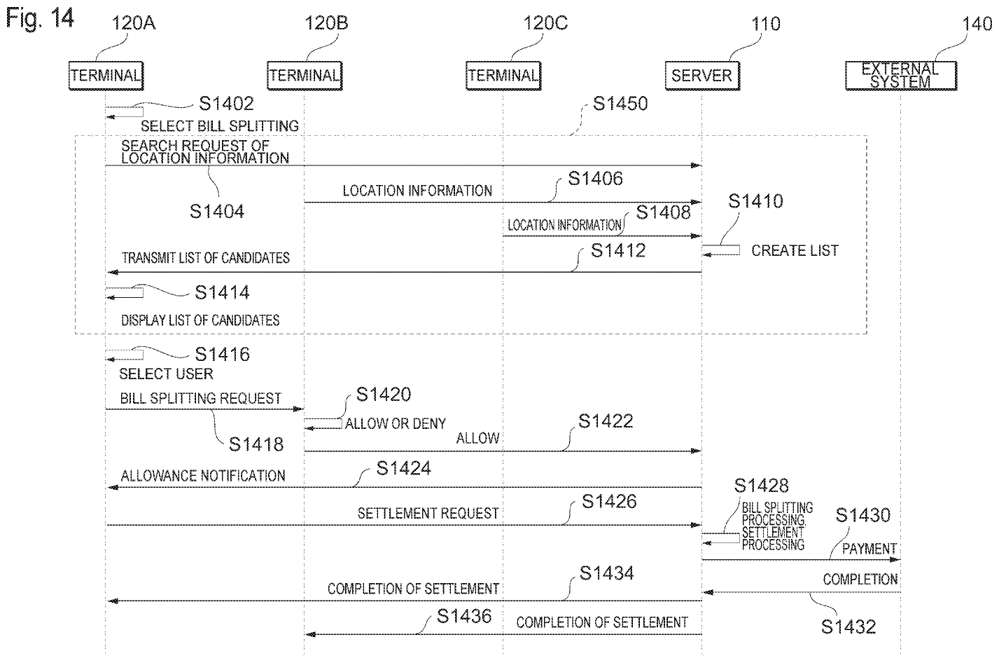

Processing of the communication system 1 according to the second embodiment will be described with reference to FIG. 14. FIG. 14 illustrates an example of a sequence of processing procedure performed by the communication system 1 according to the second embodiment. The processing illustrated in FIG. 14 is an example where positional relationship between users or terminals 120 is recognized using location information of the terminals 120, such as the GPS.

In step S1402, the input/output unit 502 of the terminal 120A accepts depression (tap) of a button for selecting bill splitting from the user on a settlement screen.

In step S1404, the location information measuring unit 1312 of the terminal 120A measures location information of the own terminal. The location information measuring unit 1312 of the terminal 120A instructs the communication unit 1304 to transmit a search request for location information to the server 110. The search request may be, for example, transmitted along with the location information of the terminal 120A or may be separately transmitted.

In step S1406, the location information measuring unit 1312 of the terminal 110B measures location information of the own terminal and instructs the communication unit 1304 to transmit the measured location information and a user ID of the user who utilizes the terminal 110B to the server 110.

In step S1408, the location information measuring unit 1312 of the terminal 110C measures location information of the own terminal and instructs the communication unit 1304 to transmit the measured location information and a user ID of the user who utilizes the terminal 110C to the server 110. Note that the location information transmitted in step S1404, S1406 and S1408 may be regularly transmitted from each terminal 120 to the server 110 or the location information may be transmitted from each terminal 120 to the server 110 on the basis of an instruction from the server 110.

In step S1410, the list creating unit 1214 of the server 110 creates a list of candidates for users who are to split the bill on the basis of the location information acquired from each terminal 120. For example, the list creating unit 1214 of the server 110 creates the list so as to include user IDs, nickname associated with user IDs, or the like, in ascending order of a distance from a location of the terminal 120A.

In step S1412, the communication unit 1204 of the server 110 transmits the list of candidates created by the list creating unit 1214 to the terminal 120A which has transmitted the search request.

In step S1414, the display control unit 1308 of the terminal 120A performs control so as to display the list of candidates acquired from the server 110 on a display screen. At this time, the list is displayed so that respective users within the list of candidates can be selected.

In step S1416, the input/output unit 1302 of the terminal 120A accepts an instruction to select users who are to split the bill from the display screen of the list of candidates. For example, in a case where a UI (User Interface) component which can be selected by the users within the list of candidates, such as a radio button, is displayed, the input/output unit 1302 accepts selection of users who are to split the bill through depression of the UI component, or the like, by the user A. Note that it is assumed in this example that the user B is selected as a user who is to split the bill.

In step S1418, the communication unit 1304 of the terminal 120A transmits a bill splitting request to the user who is to split the bill (in the example illustrated in FIG. 14, the user B) selected by the user A within the list of candidates.

In step S1420, the display control unit 1308 of the terminal 120B performs control to display a selection screen for selecting whether to allow or deny bill splitting on a display screen in response to reception of the bill splitting request.

In step S1422, the communication unit 1304 of the terminal 120B transmits an allowance notification to the server 110 in response to selection of allowance by the user B from the selection screen. By this means, by the allowance notification by the user B being transmitted from the terminal 120B of the user B to the server 110, it is possible to improve credibility of allowance. Note that, in a case where the user B denies bill splitting, settlement processing on the user A alone or bill splitting processing with another user is performed (not illustrated in FIG. 14).

In step S1424, the server 110 transmits an allowance notification by the user B to the terminal 120A when the server 110 detects that the user B allows bill splitting.

In step S1426, the communication unit 1304 of the terminal 120A transmits a settlement request to the server 110 when the communication unit 1304 receives the allowance notification from the user B. The settlement request includes a split amount of a bill or a payment amount and a store ID which is a payee, and may further include a user ID of the user A and a user ID of the user B who are to split the bill. Note that the split amount of the bill may be set for each user by the user A who uses the terminal 120A.

In step S1428, the bill splitting processing unit 1208 and the settlement processing unit 1210 of the server 110 specify a payee on the basis of information included in the settlement request and execute bill splitting processing on the user A and the user B described above, and settlement processing for a store, or the like. In step S1428, order of the bill splitting processing and the settlement processing does not matter. For example, the split amount of the bill may be drawn from the account of the user B first, and after the amount is paid to the balance of the user A, the payment amount may be paid from the user A to the account of the store. Further, after the payment amount is paid to the account of the store from the account of the user A first, the split amount of the bill may be subtracted from the balance of the user B and may be added to the balance of the user A.

In step S1430, the settlement processing unit 1210 of the server 110 performs payment processing of paying the payment amount to the external system 140 which holds the account of the store associated with the store ID which is a payee.

In step S1432, the external system 140 transmits a completion notification of payment to the server 110 when the payment is completed.

In step S1434, the communication unit 1204 of the server 110 transmits a completion notification of settlement to the terminal 120A when the communication unit 1204 receives the completion notification of payment from the external system 140.

In step S1436, the communication unit 1204 of the server 110 transmits a completion notification of settlement to the terminal 120B when the communication unit 1204 receives the completion notification of payment from the external system 140. Order of step S1434 and S1436 does not matter.

Note that the allowance notification in step S1422 may be transmitted from the terminal 120B to the terminal 120A. In this case, step S1424 is unnecessary, and user IDs of users who are to split the bill and who have allowed bill splitting are included in the settlement request in step S1426. By this means, by reducing step performed via the server 110, it is possible to realize quicker bill splitting processing.

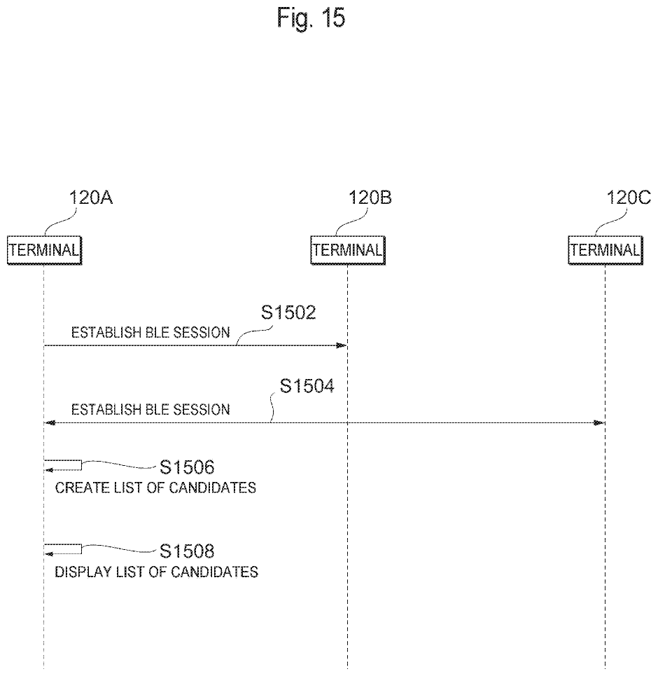

Note that the candidate list generation processing and display processing from step S1404 to step S1414 are expressed as S1450. Another processing of this step S1450 will be described using FIG. 15.

FIG. 15 illustrates an example of a sequence of processing procedure regarding creation and display of a list of candidates, performed by each terminal 120 according to the second embodiment. The processing illustrated in FIG. 15 is an example where the respective terminals 120 recognize positional relationship between users or terminals 120 using near field communication. While, in the example illustrated in FIG. 15, a session is established using BLE as a non-limitative example, a session may be established using other wireless communication such as an ultrasonic wave and Wi-Fi.

In step S1502, the communication unit 1304 of the terminal 120A establishes a session with the terminal 120B existing within a communication possible range using BLE.

In step S1504, the communication unit 1304 of the terminal 120A establishes a session with the terminal 120C existing within a communication possible range using BLE.

In step S1506, the list creating unit 1314 of the terminal 120A creates a list of candidates for users who are to split a bill on the basis of respective terminals with which the terminal 120A establishes a session. For example, the list creating unit 1314 of the terminal 120A may judge that terminals are closer to the terminal 120A as signal strength is stronger using the signal strength in wireless communication with the terminal 120A and may create a list of candidates in ascending order of a distance from the terminal 120A. Further, the list creating unit 1314 of the terminal 120A may include user IDs, nickname associated with the user IDs (hereinafter, also referred to as user IDs, or the like), in the list of candidates.

In step S1508, the display control unit 1308 of the terminal 120A performs control to display the list of candidates created by the list creating unit 1314 on a display screen. At this time, the list is displayed so that respective users within the list of candidates can be selected. The subsequent processing is similar to step S1416 illustrated in FIG. 14.

By this means, it is possible to create a list of candidates including users who are to split a bill and who are located in the vicinity of the user A also using near field communication. In a case where location information cannot be acquired using a GPS, or the like, by using near field communication in the present example, it is possible to appropriately create a list of candidates.

Note that acquisition of location information of the respective terminals using the GPS illustrated in FIG. 14 and acquisition of location information of the respective terminals using near field communication may be combined as appropriate. As a non-limitative example, a list of candidates is generated by acquisition of location information using the GPS being preferentially performed. Then, in a case where the user A has noticed that the user (for example, the user B) who is supposed to be within the list of candidates does not exist, the user A gives an instruction to create a list of candidates using near field communication. For example, it is only required that an execution button, or the like, of near field communication is provided within a display screen of the list of candidates. Further, the user who is supposed to be within the list of candidates, for example, corresponds to a situation where while the user A notices existence of the user B who is present, the user B is not included within the list of candidates. This situation can occur in a case where a user of each terminal does not allow location information of the GPS to be output in setting of application.

If the user A gives an instruction to execute near field communication from a display screen, or the like, of the list of candidates, the input/output unit 1302 of the terminal 120A detects execution of near field communication, and near field communication is executed by the communication unit 1304 of the terminal 120A. At this time, in a case where the list creating unit 1314 of the terminal 120A newly acquires a user ID, or the like, using near field communication, the list creating unit 1314 adds the acquired new user ID, or the like, to the list of candidates. In a case where the list creating unit 1314 of the terminal 120A acquires again a user ID, or the like, which has been already included in the list of candidates, the list creating unit 1314 only has to discard one of them.

By this means, by combining acquisition of location information using the GPS and acquisition of location information using near field communication, it is possible to include users who are to split a bill in the list of candidates more appropriately.

### <Display Aspect Upon Settlement Using Code According to Terminal in Second Embodiment>

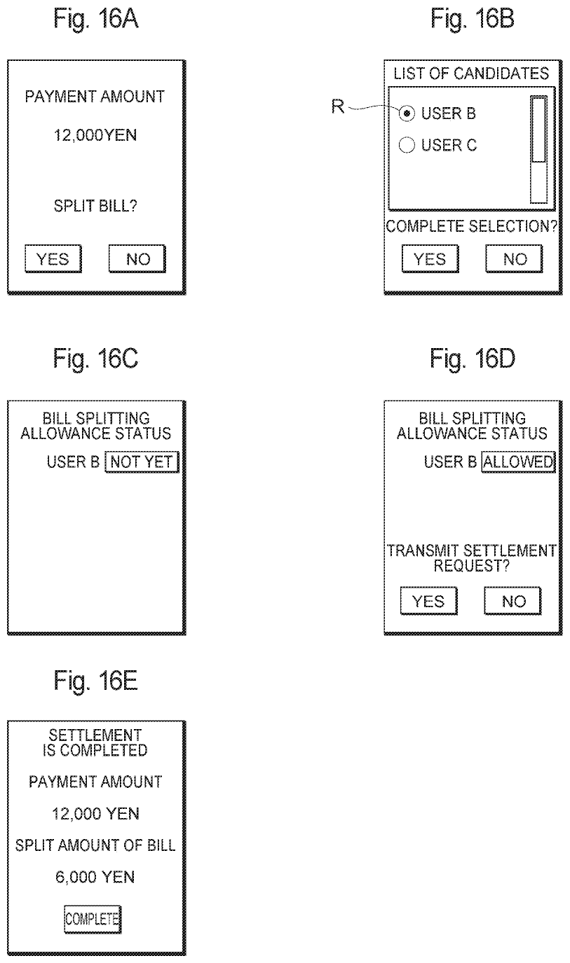

FIG. 16 illustrates an example of a screen displayed at the terminal 120A according to the second embodiment. FIG. 16A illustrates an example of a settlement screen including a payment amount and a bill splitting selection button. The settlement screen illustrated in FIG. 16A includes at least a display item of the payment amount and a selection button for bill splitting. The settlement screen illustrated in FIG. 16A corresponds to, for example, a screen displayed in processing in step S1402 illustrated in FIG. 14. In a case where the user depresses Yes on the screen illustrated in FIG. 16A, processing in step S1404 illustrated in FIG. 14 is executed, and, in a case where the user depresses No, a settlement request for settlement by himself/herself is transmitted to the server 110 (not illustrated in FIG. 14).

FIG. 16B illustrates an example of a screen on which a list of candidates is displayed. The screen illustrated in FIG. 16B includes a list of candidates created by the list creating unit 1214 of the server 110 or the list creating unit 1314 of the terminal 120A. In the example illustrated in FIG. 16B, the user B and the user C are displayed within the list of candidates, and radio buttons R with which the users can be respectively selected are displayed. Name displayed within the list of candidates only has to be information from which the user registered in the user management DB can be identified, such as nickname set by the user in application, a user ID and name. The screen illustrated in FIG. 16B corresponds to, for example, the screen displayed in the processing in step S1414 illustrated in FIG. 14.

FIG. 16C illustrates an example of a screen for waiting allowance of bill splitting. The screen illustrated in FIG. 16C illustrates a situation where the user B has not allowed bill splitting yet. For example, the screen illustrated in FIG. 16C corresponds to the screen displayed at the terminal 120A from step S1418 to S1422 illustrated in FIG. 14.

FIG. 16D illustrates an example of a notification screen of allowance of bill splitting. The display control unit 1308 of the terminal 120A performs control to display the screen illustrated in FIG. 16D after the communication unit 1304 of the terminal 120A receives an allowance notification in step S1424 illustrated in FIG. 14. In a case where the user A depresses Yes on the screen illustrated in FIG. 16D, the processing in step S1426 is executed, and, in a case where the user A depresses No, the processing may return to predetermined processing. The predetermined processing includes, but not limited to, selection of a list of candidates, or the like, in step S1414. The screen illustrated in FIG. 16D corresponds to, for example, the screen displayed after the processing in step S1424 illustrated in FIG. 14.

FIG. 16E illustrates an example of a settlement completion screen. The screen illustrated in FIG. 16E is an example of a screen for notifying the user A that payment to a store and bill splitting have been completed. The screen illustrated in FIG. 16E may be displayed on the display screen of the terminal 120A after the processing in step S1434 illustrated in FIG. 14 has been performed.

### <<First Example>>

In a first example of the second embodiment, concerning display of the list of candidates, users within the list are displayed concentrically around the user who is to make payment in accordance with a location of the user who is to make payment and locations of the users within the list of candidates. For example, the list creating unit 1214 of the server 110 arranges the respective users concentrically on the basis of the locations of the respective terminals 120 using the location information of the respective terminals 120 specified by the location specifying unit 1212. Display of the list of candidates can be applied in a case where the location information using the GPS is acquired.

### <<Effects of First Example>>

According to the present example, the user can easily recognize which user is located at which position in accordance with actual positions where the users are seated when the user watches the list of candidates, so that it is possible to easily specify users who are to split a bill from the list of candidates.

### <<Display Aspect of List of Candidates According to Terminal in First Example>>

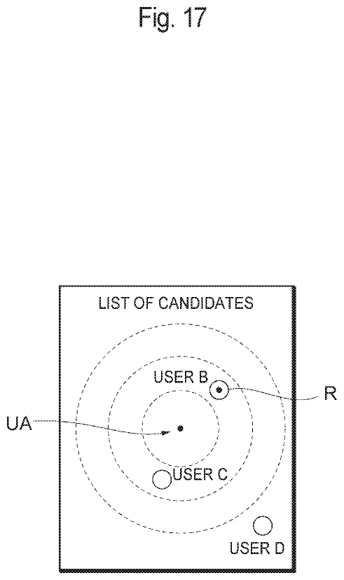

FIG. 17 illustrates an example of a display screen of a list of candidates displayed at the terminal 120A according to the first example. In the example illustrated in FIG. 17, users (for example, the user B, the user C and the user D) are displayed at respective positions within the list of candidates concentrically around the user UA who is to make payment. Note that a dotted circle radially displayed, which is illustrated in FIG. 17, is displayed for each predetermined distance. For example, the predetermined distance is designed so that the user can change the distance to 3 meters, 5 meters, or the like, from a setting screen, or the like. Further, the list of candidates illustrated in FIG. 17 may be displayed while a position is shifted as in map operation through user operation such as drag or a scale is changed through user operation such as pinching out.

### <<Second Example>>

In a second example of the second embodiment, the settlement control unit 1310 of the terminal 120A of the user A who is to make payment transmits a settlement request including a user ID and a split amount of bill for each user when the settlement control unit 1310 transmits the settlement request to the server 110. The communication unit 1204 of the server 110 receives the settlement request for each user, and the settlement processing unit 1210 executes processing of paying the split amount of the bill to an account of a store for each user. The server 110 notifies the terminal 120 of each user of completion of settlement in accordance with a form as a receipt when the server 110 make a completion notification of settlement. The form as a receipt includes, but not limited to, items such as date, address, an amount, proviso, store name, and seal of the store.

### <<Effects of Second Example>>

According to the present example, because each user can receive a receipt of his/her own, each user can pay the split amount of the bill as expense.

### <<Display Aspect of Completion Notification of Settlement According to Terminal in Second Example>>

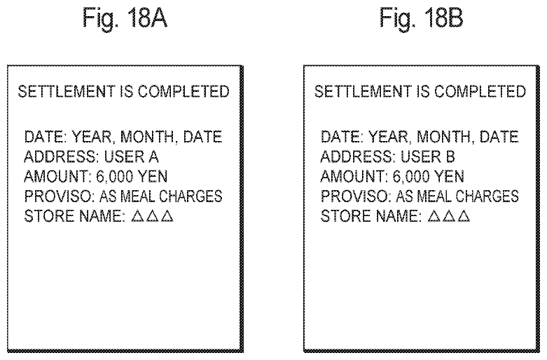

FIG. 18 illustrates an example of a display screen of a completion notification of settlement displayed at the terminal 120 according to the second example. In the example illustrated in FIG. 18A, the completion notification of settlement of the user A is displayed on a display screen of the terminal 120A. The completion notification of settlement illustrated in FIG. 18A includes, but not limited to, date, address, an amount, proviso, store name, or the like.

In the example illustrated in FIG. 18B, the completion notification of settlement of the user B is displayed on a display screen of the terminal 120B. The completion notification of settlement illustrated in FIG. 18B includes, but not limited to, date, address, an amount, proviso, store name, or the like.

Further, electronic stamp indicating seal of the store may be provided at this completion notification of settlement. The server 110 holds the electronic stamp in association with a store ID, or the like. The server 110 may read out this electronic stamp and provide the electronic stamp to the completion notification of settlement when the server 110 receives the completion notification of payment from the external system 140.

Further, the address may be registered in advance in the server 110 for each user. For example, an item of address for making a completion notification of settlement is provided for each user ID in the user management DB, and the user may be caused to register name, company name, or the like, in advance. Further, when a notification of the settlement request is made, or when bill splitting processing is allowed, the user may be caused to input address and/or proviso each time. The display control unit 1308 of each terminal 120 displays a UI component for inputting address and/or proviso on a display screen and transmits the address and/or proviso input to this UI component to the server 110 in association with a settlement ID or the like. The server 110 holds the received address and/or proviso and includes the held address and/or proviso in the completion notification of settlement when the server 110 transmits the completion notification of settlement to each terminal 120. By this means, each user can receive the completion notification of settlement which can be a receipt.

### <<Third Example>>

In a third example of the second embodiment, the server 110 confirms whether or not user information (such as, for example, a user ID) can be transmitted, to users who are to split a bill when the server 110 creates a list of candidates. For example, before the server 110 creates a list of candidates of users who are to split a bill, the server 110 makes an inquiry to the users who are to split a bill as to whether or not user information can be transmitted. For example, after the processing in step S1406 and step S1408 illustrated in FIG. 14, the server 110 makes an inquiry to the respective terminals (for example, the terminal 120B and the terminal 120C) as to whether or not user information can be transmitted. The list creating unit 1214 of the server 110 acquires whether or not user information can be transmitted, from the respective terminals, and includes a user who allows transmission in the list of candidates.

### <<Effects of Third Example>>

According to the present example, because the respective users can determine whether or not he/she tells his/her user information to other users, it is possible to prevent user information from being transmitted to other terminals without permission, so that it is possible to improve security. Note that each user may select in advance through a setting screen of application, or the like, whether his/her user information is transmitted without permission, or an inquiry is made each time as to whether or not user information can be transmitted, or transmission of user information is not allowed. By this means, it is possible to set whether or not user information can be transmitted and/or an inquiry timing in accordance with desire of the user. The server 110 may store transmission setting of user information set in advance in association with the user IDs in the user management DB.

Further, according to the respective embodiments and the respective examples described above, in addition to the operational effects which have been already described, it is possible to improve operability, usability, or the like, of the information processing device and the terminal as a result of execution of the above-described application and information processing method.

### <Supplement>

### (Supplement 1-1)

A computer-readable non-transitory storage medium storing a program causing an information processing device to execute processing of:

performing control to display a first information code including a payment amount on a display screen, acquiring a split amount of a bill calculated using the total number of users who are to split a bill based on respective pieces of account information and at least part of the payment amount on the basis of settlement pre-processing processed by a server which has received the account information transmitted by the respective information processing devices which have scanned the information code,

performing control to display a second information code which becomes a trigger for causing the server to execute settlement processing including bill splitting processing using the split amount of the bill, on the display screen, and

receiving a completion notification of the settlement processing or the bill splitting processing from the server.

### (Supplement 1-2)

The computer-readable non-transitory storage medium according to the supplement 1-1 for causing the information processing device to further execute receiving the respective pieces of account information transmitted in accordance with the settlement pre-processing by the server,

the acquiring the split amount of the bill including

calculating the total number of users who are to split the bill on the basis of the received respective pieces of account information, and

calculating the split amount of the bill using at least part of the payment amount and the total number.

### (Supplement 1-3)

The computer-readable non-transitory storage medium according to the supplement 1-1 or 1-2, for causing the information processing device to further execute performing control to display a generation auxiliary screen of the first information code on the display screen,

accepting input of the payment amount on the basis of user operation on the generation auxiliary screen, and

generating the first information code including the input payment amount,

the performing control to display the first information code including

performing control to display the generated information code on the display screen.

### (Supplement 1-4)

The computer-readable non-transitory storage medium according to any one of the supplement 1-1 to 1-3, for causing the information processing device to further execute

performing control to display an adjustment screen for adjusting the total number on the display screen, and

accepting the adjusted total number on the basis of user operation on the adjustment screen,

the acquiring the split amount of the bill including

calculating a split amount of a bill using the adjusted total number and at least part of the payment amount.

### (Supplement 1-5)

The computer-readable non-transitory storage medium according to any one of the supplement 1-1 to 1-4, for causing the information processing device to further execute

transmitting a confirmation request for confirming whether or not balance of a user who is to split a bill is equal to or greater than the split amount of a bill to the server, after acquisition of the split amount of the bill, and

receiving a confirmation result for the confirmation request from the server.

### (Supplement 1-6)

The computer-readable non-transitory storage medium according to the supplement 1-1, for causing the information processing device to further execute

in a case where there is predetermined relationship between a first user who utilizes the information processing device and other respective users who utilize the respective information processing devices, performing control to display at least part of information of users having the predetermined relationship on the display screen in an aspect different from that of at least part of information of users who do not have the predetermined relationship.

### (Supplement 1-7)

The computer-readable non-transitory storage medium according to any one of the supplement 1-1 to 1-6,

in which, in a case where the settlement processing is executed after the bill splitting processing,

the receiving the completion notification includes

receiving a completion notification of the bill splitting processing, and

receiving a completion notification of the settlement processing after reception of the completion notification of the bill splitting processing.

### (Supplement 1-8)

The computer-readable non-transitory storage medium according to any one of the supplement 1-1 to 1-6,

in which, in a case where the settlement processing is executed before the bill splitting processing,

the receiving the completion notification includes

receiving a completion notification of the settlement processing, and

receiving a completion notification of the bill splitting processing after reception of the completion notification of the settlement processing.

### (Supplement 1-9)

The computer-readable non-transitory storage medium according to any one of the supplement 1-1 to 1-8,

in which the first information code and the second information code are the same information code.

### (Supplement 1-10)

A computer-readable non-transitory storage medium storing a program for causing an information processing device to execute the processing of:

scanning an information code including settlement information associated with a store,

transmitting the settlement information included in the information code and account information of a first user who utilizes the information processing device, to a server,

acquiring a split amount of a bill calculated using the total number of respective pieces of account information and at least part of a payment amount associated with the settlement information on the basis of settlement pre-processing processed by a server which has received the account information transmitted from respective information processing devices which have scanned the information code,

transmitting a settlement request for requesting settlement processing including bill splitting processing using the split amount of the bill, to the server, and

receiving a completion notification of the settlement processing or the bill splitting processing from the server.

### (Supplement 1-11)

The computer-readable non-transitory storage medium according to the supplement 1-10,

in which the step of acquiring the split amount of the bill includes

receiving the split amount of the bill calculated by the server, and

the split amount of the bill is calculated using the total number based on account information of the respective information processing devices which have scanned the information code displayed at an information processing terminal, and at least part of the payment amount included in the information code.

### (Supplement 1-12)

The computer-readable non-transitory storage medium according to the supplement 1-10,

in which the settlement information includes payee identification information in which the store is set as a payee,

the program causes the information processing device to further execute

transmitting the payee identification information included in the information code and account information of a first user who utilizes the information processing device to the server, and

the acquiring the split amount of the bill includes

receiving the split amount of the bill calculated on the basis of a payment amount, from the server which has received a payment request including the payment amount from an information processing terminal.

### (Supplement 1-13)

The computer-readable non-transitory storage medium according to the supplement 1-1 or 1-10,

in which the step of acquiring the split amount of the bill includes a step of executing rounding processing on the split amount of the bill of each user when the payment amount cannot be divided evenly by the total number.

### (Supplement 1-14)

The computer-readable non-transitory storage medium according to the supplement 1-13,

in which the rounding processing includes processing of determining the split amount of the bill of each user by rounding up or rounding down a quotient of each user when the payment amount cannot be divided evenly by the total number.

### (Supplement 1-15)

The computer-readable non-transitory storage medium according to the supplement 1-13,

in which the rounding processing includes processing of determining the split amount of the bill of each user by rounding down a quotient of each user when the payment amount cannot be divided evenly by the total number, and

processing of discounting from the payment amount, an amount obtained by subtracting a total of the split amounts of the bill of the respective users from the payment amount, is executed by the server.

### (Supplement 1-16)

The computer-readable non-transitory storage medium according to the supplement 1-13,

in which the rounding processing includes processing of determining the split amount of the bill of each user by rounding up a quotient of each user when the payment amount cannot be divided evenly by the total number, and

processing of paying an amount obtained by subtracting the payment amount from a total of the split amounts of the bill of the respective users to a settlement service provider, is executed by the server.

### (Supplement 1-17)

An information processing device including

a first receiving unit configured to receive respective pieces of account information transmitted from respective information processing devices which have scanned an information code including a payment amount,

a settlement pre-processing unit configured to perform settlement pre-processing for determining a split amount of a bill based on a total number of the respective pieces of account information and at least part of the payment amount in response to reception of the respective pieces of account information,

a second receiving unit configured to receive a settlement request transmitted by an information scanning terminal which has scanned the information code displayed at least one of the information processing devices,

a settlement processing unit configured to perform settlement processing of paying the payment amount to a store indicated with store information included in the settlement request from an account of a first user who utilizes the information processing device which has transmitted the settlement request,

a bill splitting processing unit configured to perform processing of paying the split amount of the bill to the first user from accounts of respective users associated with the respective pieces of account information other than user information of the first user, and

a transmitting unit configured to transmit a completion notification of the settlement processing to the information processing device of the first user in a case where the settlement processing has been completed.

### (Supplement 1-18)

An information processing method to be executed by an information processing device, including receiving respective pieces of account information transmitted from respective information processing devices which have scanned an information code including a payment amount,

performing account processing for determining a split amount of a bill based on the total number of the respective pieces of account information and at least part of the payment amount in response to reception of the respective pieces of account information,

receiving a settlement request transmitted by an information processing terminal which has scanned the information code displayed at least one of the information processing devices,

performing settlement processing of paying the payment amount to a store indicated with store information included in the settlement request from an account of a first user who utilizes the information processing device which has transmitted the settlement request,

performing processing of paying the split amount of the bill to the first user from accounts of respective users associated with the respective pieces of account information other than user information of the first user, and

transmitting a completion notification of the settlement processing to the information processing device of the first user in a case where the settlement processing has been completed.

### (Supplement 1-19)

An information processing device including

a first receiving unit configured to receive account information transmitted by respective information processing devices which have scanned an information code including settlement information associated with a store,

a settlement pre-processing unit configured to perform settlement pre-processing for determining a split amount of a bill based on the total number of respective pieces of the account information and at least part of a payment amount associated with the settlement information in response to reception of the respective pieces of account information,

a second receiving unit configured to receive a settlement request including the payment amount and store information transmitted from an information processing terminal or a settlement request including the split amount of the bill and the store information transmitted from the information processing device,

a settlement and bill splitting processing unit configured to perform settlement processing of paying the payment amount to a store indicated with store information included in the settlement request and bill splitting processing in accordance with the split amounts of the bill of respective users associated with the respective pieces of account information, and

a transmitting unit configured to transmit a completion notification of the settlement processing or the bill splitting processing to the respective information processing devices in a case where the settlement processing or the bill splitting processing has been completed.

### (Supplement 1-20)

An information processing method to be executed by an information processing device, including

receiving account information transmitted by respective information processing devices which have scanned an information code including settlement information associated with a store,

performing settlement pre-processing for determining a split amount of a bill based on the total number of respective pieces of the account information and at least part of a payment amount associated with the settlement information in response to reception of the respective pieces of account information,

receiving a settlement request including the payment amount and the store information transmitted from an information processing terminal, or a settlement request including the split amount of the bill and the store information transmitted from the information processing device,

performing settlement processing of paying the payment amount to a store indicated with store information included in the settlement request and bill splitting processing in accordance with the split amounts of the bill of respective users associated with the respective pieces of account information, and

transmitting a completion notification of the settlement processing or the bill splitting processing to the respective information processing devices in a case where the settlement processing or the bill splitting processing has been completed.

### (Supplement 2-1)

A computer-readable non-transitory storage medium storing a program for causing an information processing device to execute the processing of:

accepting selection of bill splitting processing from a first user who utilizes the information processing device,

acquiring a list of candidates including users who satisfy a predetermined condition regarding a distance from the first user,

accepting selection of at least one second user from the list of candidates,

transmitting a settlement request for executing settlement processing including bill splitting processing for splitting a bill between the first user and the second user, to a server, and

receiving a completion notification of the bill splitting processing or the settlement processing executed on the basis of the settlement request, from the server.

### (Supplement 2-2)

The computer-readable non-transitory storage medium according to the supplement 2-1, for causing the information processing device to further execute

transmitting a confirmation request for confirming the bill splitting processing to another information processing device utilized by the second user, and

receiving a response to the confirmation request from the other information processing device,

in which the step of transmitting the confirmation request includes a step of transmitting the settlement request to the server in a case where the response indicates allowance of the bill splitting processing.

### (Supplement 2-3)

The computer-readable non-transitory storage medium according to the supplement 2-1 or 2-2,

in which the predetermined condition is a condition that a distance between the first user and the other user is within a predetermined range.

### (Supplement 2-4)

The computer-readable non-transitory storage medium according to the supplement 2-3,

in which the predetermined condition is a condition that the first user and the other user are located within a communication possible range using signal strength in near field communication.

### (Supplement 2-5)

The computer-readable non-transitory storage medium according to the supplement 2-3,

in which the predetermined condition is a condition that a distance between the information processing device of the first user and an information processing device of the other user is within a predetermined range using location information output by the respective information processing devices.

### (Supplement 2-6)

The computer-readable non-transitory storage medium according to the supplement 2-3,

in which the predetermined condition includes a first condition that the first user and the other user are located within a communication possible range using signal strength in near field communication, and a second condition that a distance between the information processing device of the first user and an information processing device of the other user is within a predetermined range using location information output by the respective information processing devices, and

in a case where priority is provided to the first condition and the second condition, if a user is not found with a condition having the higher priority, a user is searched for using the other condition.

### (Supplement 2-7)

The computer-readable non-transitory storage medium according to any one of the supplement 2-1 to 2-6, for causing the information processing device to further execute

performing control to display users within the list of candidates on a display screen concentrically around a location of the first user in accordance with the location of the first user and locations of the users within the list of candidates.

### (Supplement 2-8)

The computer-readable non-transitory storage medium according to any one of the supplement 2-1 to 2-7,

in which the settlement request includes identification information of users who are to split a bill and a split amount of the bill for each of the users who are to split the bill.

### (Supplement 2-9)

An information processing device including

a first receiving unit configured to receive a search request for searching for users who satisfy a predetermined condition regarding a distance from a first user who utilizes a first information processing device, from the first information processing device,

a location specifying unit configured to specify locations of the users who satisfy the predetermined conditions in response to reception of the search request;

a first transmitting unit configured to transmit a list of candidates including the users who satisfy the predetermined conditions, to the first information processing device,

a second receiving unit configured to receive a settlement request for executing settlement processing including bill splitting processing of splitting a bill between at least one second user selected from the list of candidates and the first user, and

a settlement processing unit configured to execute the bill splitting processing and the settlement processing in response to the settlement request.

### (Supplement 2-10)

The information processing device according to the supplement 2-9, further including

a third receiving unit configured to receive information indicating allowance of bill splitting processing from a second information processing device which is utilized by at least one second user selected from the list of candidates, and

a second transmitting unit configured to transmit the information indicating allowance of bill splitting processing and identification information of the second user to the first information processing device,

in which the second receiving unit receives a settlement request for executing bill splitting processing and settlement processing, including identification information of the first user and users who are to split a bill including the second user, from the first information processing device.

### (Supplement 2-11)

The information processing device according to the supplement 2-9 or 2-10,

in which the settlement processing unit executes the bill splitting processing of subtracting a split amount of a bill calculated using the total number of the users who are to split the bill and a payment amount from balance of the respective users who are to split the bill, and

executes the settlement processing of adding the respective split amounts of the bill to balance of an account of a payee.

### (Supplement 2-12)

The information processing device according to the supplement 2-9 or 2-10,

in which the settlement processing unit executes the settlement processing of subtracting a payment amount from balance of the first user and adding the payment amount to balance of an account of a payee, and

executes the bill splitting processing of subtracting a split amount of a bill calculated using the total number of the users who are to split the bill and the payment amount from balance of the respective second users, and adding the split amount of the bill to the balance of the first user.

### (Supplement 2-13)

The information processing device according to any one of the supplement 2-9 to 2-12,

in which the location specifying unit provides priority to the users within the list of candidates in ascending order of a distance from the first user.

### (Supplement 2-14)

The information processing device according to the supplement 2-13,

in which the location specifying unit estimates a distance between the first user and another user using signal strength in near field communication and/or location information output by the respective information processing devices.

### (Supplement 2-15)

An information processing method at an information processing device, including

receiving a search request for searching for users who satisfy a predetermined condition regarding predetermined relationship with a first user who utilizes a first information processing device, from the first information processing device,

specifying locations of the users who satisfy the predetermined condition in response to reception of the search request,

transmitting a list of candidates including the users who satisfy the predetermined condition to the first information processing device,

receiving a settlement request for executing settlement processing including bill splitting processing of splitting a bill between at least one second user selected from the list of candidates and the first user, and

executing the bill splitting processing and the settlement processing in response to the settlement request.

### (Supplement 3-1)

A computer-readable non-transitory storage medium storing a program for causing one or a plurality of processor included in an information processing device to execute processing of

displaying a first information code,

acquiring account information associated with one or a plurality of other information processing terminals which have scanned the first information code,

displaying a second information code regarding payment, and

displaying a split amount of a bill which is to be paid by users corresponding to the account information regarding payment of the second information code.

### (Supplement 3-2)

The computer-readable non-transitory storage medium according to the supplement 3-1, storing a program for causing the one or the plurality of processors to further execute processing of

adjusting the split amount of the bill.

### (Supplement 3-3)

An information processing method to be executed by one or a plurality of processors included in an information processing device, the information processing method including processing of

displaying a first information code,

acquiring account information associated with one or a plurality of other information processing terminals which have scanned the first information code,

displaying a second information code regarding payment, and

displaying a split amount of a bill which is to be paid by users corresponding to the account information regarding payment of the second information code.

### (Supplement 3-4)

An information processing device including one or a plurality of processors, the one or the plurality of processors executing processing of

displaying a first information code,

acquiring account information associated with one or a plurality of other information processing terminals which have scanned the first information code,

displaying a second information code regarding payment, and

displaying a split amount of a bill which is to be paid by users corresponding to the account information regarding payment of the second information code.

### REFERENCE SIGNS LIST

1 communication system
100 communication system
110 server
110A server
110B server
120 terminal
120A terminal
120B terminal
120C terminal
120X terminal
130 terminal
130A POS terminal
130B POS terminal
200 information processing device
201 processor
202 memory
203 storage
204 input/output interface (input/output I/F)
205 communication interface (communication I/F)
302 input/output unit
304 communication unit
306 settlement pre-processing unit
308 bill splitting processing unit
310 settlement processing unit
312 storage unit
502 input/output unit
504 communication unit
506 generating unit
508 display control unit
510 acquiring unit
512 adjusting unit
514 settlement control unit
516 scanning unit

### FIG. 1

125 NETWORK
140 EXTERNAL SYSTEM

### FIG. 2

200 INFORMATION PROCESSING DEVICE
201 PROCESSOR
202 MEMORY
203 STORAGE
204 INPUT/OUTPUT I/F
205 COMMUNICATION I/F

### FIG. 3

302 INPUT/OUTPUT UNIT
304 COMMUNICATION UNIT
306 SETTLEMENT PRE-PROCESSING UNIT
308 BILL SPLITTING PROCESSING UNIT
310 SETTLEMENT PROCESSING UNIT
312 STORAGE UNIT
#1 PROGRAM
#2 USER MANAGEMENT DB
#3 RELATION MANAGEMENT DB
#4 SETTLEMENT MANAGEMENT DB

### FIG. 4A

#1 USER ID
#2 PASSWORD
#3 BALANCE

### FIG. 4B

#1 GROUP ID
#2 USER ID

### FIG. 4C

#1 DATE AND TIME
#2 STORE ID
#3 USER ID
#4 PAYMENT AMOUNT

### FIG. 5

502 INPUT/OUTPUT UNIT
504 COMMUNICATION UNIT
506 GENERATING UNIT
508 DISPLAY CONTROL UNIT
510 ACQUIRING UNIT
512 ADJUSTING UNIT
514 SETTLEMENT CONTROL UNIT
516 SCANNING UNIT
518 STORAGE UNIT
#1 PROGRAM

### FIG. 6

602 TOTAL NUMBER CALCULATING UNIT
604 SPLIT BILL AMOUNT CALCULATING UNIT

### FIG. 7

#1 USER A
120A, 120B, 120C TERMINAL
110 SERVER
130 POS TERMINAL
S702 INPUT PAYMENT AMOUNT, SELECT PAYMENT BY SPLITTING BILL
S704 GENERATE TWO-DIMENSIONAL CODE FOR BILL SPLITTING
S706 DISPLAY TWO-DIMENSIONAL CODE FOR BILL SPLITTING
S708 SCAN TWO-DIMENSIONAL CODE
S710 TRANSMISSION REQUEST OF ACCOUNT INFORMATION
S712 TRANSMIT ACCOUNT INFORMATION
S714 SCAN TWO-DIMENSIONAL CODE
S716 TRANSMISSION REQUEST OF ACCOUNT INFORMATION
S718 TRANSMIT ACCOUNT INFORMATION
S720 ADJUST NUMBER OF USERS WHO ARE TO SPLIT BILL
S722 DETERMINE SPLIT AMOUNT OF BILL
S724 REQUEST FOR ACCOUNT AUTHENTICATION AND BALANCE CONFIRMATION
S726 ACCOUNT AUTHENTICATION AND BALANCE CONFIRMATION
S728 COMPLETION OF ACCOUNT AUTHENTICATION AND BALANCE CONFIRMATION
S730 DISPLAY TWO-DIMENSIONAL CODE
S732 SCAN TWO-DIMENSIONAL CODE
S734 SETTLEMENT REQUEST
S736 BILL SPLITTING PROCESSING, SETTLEMENT PROCESSING
S738 COMPLETION
S740 COMPLETION

### FIG. 8A

#1 INPUT PAYMENT AMOUNT
#2 YEN
#3 SPLIT BILL?

### FIG. 8B

#1 TWO-DIMENSIONAL CODE

### FIG. 8C

#1 NUMBER OF USERS WHO ARE TO SPLIT BILL
#2 SPLIT AMOUNT OF BILL
#3 3,200 YEN
#4 IS IT OK?

### FIG. 8D

#1 REQUEST FOR ACCOUNT AUTHENTICATION AND BALANCE CONFIRMATION HAS BEEN TRANSMITTED.

### FIG. 8E

#1 ACCOUNT AUTHENTICATION AND BALANCE CONFIRMATION HAVE BEEN COMPLETED.
#2 MAKE SETTLEMENT?

### FIG. 8F

#1 SETTLEMENT IS COMPLETED
#2 16,000 YEN

### FIG. 9

120A, 120B TERMINAL
110 SERVER
S902 GENERATE TWO-DIMENSIONAL CODE
S904 DISPLAY TWO-DIMENSIONAL CODE
S906 SCAN TWO-DIMENSIONAL CODE
S908 TRANSMISSION REQUEST OF ACCOUNT INFORMATION
S910 DETERMINE RELATIONSHIP
S912 NOTIFICATION OF DETERMINATION RESULT
S914 DISPLAY DETERMINATION RESULT
S916 SETTLEMENT REQUEST
S918 BILL SPLITTING PROCESSING, SETTLEMENT PROCESSING
S920 COMPLETION NOTIFICATION

### FIG. 10

130 POS TERMINAL
120A, 120B, 120C TERMINAL
110 SERVER
S1002 DISPLAY TWO-DIMENSIONAL CODE
S1004 SCAN TWO-DIMENSIONAL CODE
S1006 TRANSMIT ACCOUNT INFORMATION
S1008 SCAN TWO-DIMENSIONAL CODE
S1010 TRANSMIT ACCOUNT INFORMATION, OR THE LIKE
S1012 SCAN TWO-DIMENSIONAL CODE
S1014 TRANSMIT ACCOUNT INFORMATION, OR THE LIKE
S1016 DETERMINE SPLIT AMOUNT OF BILL
S1018 NOTIFICATION OF SPLIT AMOUNT OF BILL
S1020 NOTIFICATION OF SPLIT AMOUNT OF BILL
S1022 NOTIFICATION OF SPLIT AMOUNT OF BILL
S1024 SETTLEMENT REQUEST
S1026 SETTLEMENT REQUEST
S1028 SETTLEMENT REQUEST
S1030 BILL SPLITTING PROCESSING, SETTLEMENT PROCESSING
S1032 COMPLETION NOTIFICATION
S1034 COMPLETION NOTIFICATION
S1036 COMPLETION NOTIFICATION

### FIG. 11

120C, 120A, 120B TERMINAL
110 SERVER
S1102 DISPLAY TWO-DIMENSIONAL CODE
S1104 SCAN TWO-DIMENSIONAL CODE
S1106 TRANSMIT STORE INFORMATION AND ACCOUNT INFORMATION
S1108 SCAN TWO-DIMENSIONAL CODE
S1110 TRANSMIT STORE INFORMATION AND ACCOUNT INFORMATION
S1112 DETERMINE PAYMENT AMOUNT
S1114 PAYMENT REQUEST
S1116 DETERMINE SPLIT AMOUNT OF BILL
S1118 NOTIFICATION OF SPLIT AMOUNT OF BILL
S1120 NOTIFICATION OF SPLIT AMOUNT OF BILL
S1122 SETTLEMENT REQUEST
S1124 SETTLEMENT REQUEST
S1126 BILL SPLITTING PROCESSING, SETTLEMENT PROCESSING
S1128 COMPLETION NOTIFICATION
S1130 COMPLETION NOTIFICATION
S1132 COMPLETION NOTIFICATION

### FIG. 12

1202 INPUT/OUTPUT UNIT
1204 COMMUNICATION UNIT
1206 SETTLEMENT PRE-PROCESSING UNIT
1208 BILL SPLITTING PROCESSING UNIT
1210 SETTLEMENT PROCESSING UNIT
1212 LOCATION SPECIFYING UNIT
1214 LIST GENERATING UNIT
1216 STORAGE UNIT
#1 PROGRAM
#2 USER MANAGEMENT DB
#3 RELATION MANAGEMENT DB
#4 SETTLEMENT MANAGEMENT DB

### FIG. 13

1302 INPUT/OUTPUT UNIT
1304 COMMUNICATION UNIT
1306 SCANNING UNIT
1308 DISPLAY CONTROL UNIT
1310 SETTLEMENT CONTROL UNIT
1312 LOCATION INFORMATION MEASURING UNIT
1314 LIST GENERATING UNIT
1316 STORAGE UNIT
#1 PROGRAM

### FIG. 14

120A, 120B, 120C TERMINAL
110 SERVER
140 EXTERNAL SYSTEM
S1402 SELECT BILL SPLITTING
S1404 SEARCH REQUEST OF LOCATION INFORMATION
S1406 LOCATION INFORMATION
S1408 LOCATION INFORMATION
S1410 CREATE LIST
S1412 TRANSMIT LIST OF CANDIDATES
S1414 DISPLAY LIST OF CANDIDATES
S1416 SELECT USER
S1418 BILL SPLITTING REQUEST
S1420 ALLOW OR DENY
S1422 ALLOW
S1424 ALLOWANCE NOTIFICATION
S1426 SETTLEMENT REQUEST
S1428 BILL SPLITTING PROCESSING, SETTLEMENT PROCESSING
S1430 PAYMENT
S1432 COMPLETION
S1434 COMPLETION OF SETTLEMENT
S1436 COMPLETION OF SETTLEMENT

### FIG. 15

120A, 120B, 120C TERMINAL
S1502 ESTABLISH BLE SESSION
S1504 ESTABLISH BLE SESSION
S1506 CREATE LIST OF CANDIDATES
S1508 DISPLAY LIST OF CANDIDATES

### FIG. 16A

#1 PAYMENT AMOUNT
#2 12,000 YEN
#3 SPLIT BILL?

### FIG. 16B

#1 LIST OF CANDIDATES
#2 USER B
#3 USER C
#4 COMPLETE SELECTION?

### FIG. 16C

#1 BILL SPLITTING ALLOWANCE STATUS
#2 USER B
#3 NOT YET

### FIG. 16D

#1 BILL SPLITTING ALLOWANCE STATUS
#2 USER B
#3 ALLOWED
#4 TRANSMIT SETTLEMENT REQUEST?

### FIG. 16E

#1 SETTLEMENT IS COMPLETED
#2 PAYMENT AMOUNT
#3 12,000 YEN
#4 SPLIT AMOUNT OF BILL
#5 6,000 YEN
#6 COMPLETE

### FIG. 17

#1 LIST OF CANDIDATES
#2 USER B
#3 USER C
#4 USER D

### FIG. 18A

#1 SETTLEMENT IS COMPLETED
#2 DATE: YEAR, MONTH, DATE
#3 ADDRESS: USER A
#4 AMOUNT: 6,000 YEN
#5 PROVISO: AS MEAL CHARGES
#6 STORE NAME

### FIG. 18B

#1 SETTLEMENT IS COMPLETED
#2 DATE: YEAR, MONTH, DATE
#3 ADDRESS: USER B
#4 AMOUNT: 6,000 YEN
#5 PROVISO: AS MEAL CHARGES
#6 STORE NAME

What is claimed is:

1. An information processing method to be executed by one or a plurality of processors included in an information processing device, the information processing method comprising:
electronically transmitting a first information code to a first information processing terminal;
electronically specifying account information associated with one or a plurality of other information processing terminals which have scanned the first information code;
electronically transmitting the specified account information to the first information processing terminal;
electronically transmitting a second information code which is to be utilized for payment, to the first information processing terminal;
electronically receiving a request in accordance with scanning of the second information code; and
electronically executing bill splitting processing using a split amount of a bill based on the specified account information and a payment amount of the payment after reception of the request.

2. The information processing method according to claim 1,
wherein the split amount of the bill is determined on a basis of the payment amount and a total number of pieces of the account information.

3. The information processing method according to claim 1,
wherein the split amount of the bill is determined by dividing the payment amount by a number obtained by adding 1 to the total number of pieces of the account information.

4. The information processing method according to claim 1,
wherein the split amount of the bill is determined to be an amount designated by the first information processing terminal regarding the payment amount.

5. The information processing method according to claim 1, to be executed by the one or the plurality of processors, the information processing method further comprising:
electronically acquiring a number obtained by adjusting the total number of pieces of the account information, from the first information processing terminal,
wherein the processing of executing the bill splitting processing includes processing of executing bill splitting processing using a split amount of a bill based on the number obtained by adjusting the total number of pieces of the account information and the payment amount.

6. The information processing method according to claim 1,
wherein the bill splitting processing includes subtracting the payment amount from balance of the first information processing terminal, subtracting the respective split amounts of the bill from balance of the other information processing terminals, and adding the respective split amounts of the bill to the balance of the first information processing terminal.

7. The information processing method according to claim 1,
wherein building of relationship between account information associated with the first information processing terminal and account information associated with the other information processing terminals is approved by each other.

8. The information processing method according to claim 1,
wherein the first information code and the second information code are the same information code.

9. An information processing device including one or a plurality of processors,
the one or the plurality of processors
electronically transmitting a first information code to a first information processing terminal,
electronically specifying account information associated with one or a plurality of other information processing terminals which have scanned the first information code,
electronically transmitting the specified account information to the first information processing terminal,
electronically transmitting a second information code which is to be utilized for payment, to the first information processing terminal,
electronically receiving a request in accordance with scanning of the second information code, and
electronically executing bill splitting processing using a split amount of a bill based on the specified account information and a payment amount of the payment after reception of the request.

10. A computer-readable non-transitory storage medium storing a program for causing one or a plurality of processors included in an information processing device to execute processing of:
electronically transmitting a first information code to a first information processing terminal;
electronically specifying account information associated with one or a plurality of other information processing terminals which have scanned the first information code;
electronically transmitting the specified account information to the first information processing terminal;
electronically transmitting a second information code which is to be utilized for payment, to the first information processing terminal;
electronically receiving a request in accordance with scanning of the second information code; and
electronically executing bill splitting processing using a split amount of a bill based on the specified account information and a payment amount of the payment after reception of the request.
